(19) United States
(12) Patent Application Publication
(10) Pub. No.: US 2012/0284279 A1
(43) Pub. Date: Nov. 8, 2012

(54) CODE STRING SEARCH APPARATUS, SEARCH METHOD, AND PROGRAM

(75) Inventors: Toshio Shinjo, Chiba (JP); Mitsuhiro Kokubun, Chiba (JP)

(73) Assignee: S. Grants Co., Ltd., Chiba (JP)

(21) Appl. No.: 13/552,399

(22) Filed: Jul. 18, 2012

Related U.S. Application Data
(63) Continuation of application No. PCT/JP2011/000120, filed on Jan. 13, 2011.

(30) Foreign Application Priority Data
Jan. 18, 2010 (JP) 2010-008245

(51) Int. Cl. G06F 17/30

(52) U.S. Cl. 707/741; 707/769; 707/E17.002; 707/E17.014

(57) ABSTRACT

An index data configuration adapted to a code-string search method for a structured code string having data codes, first separator codes that separate a data code or a data code string and second separator codes that divide a code string into partial code strings. The configuration has a code ID range table holding the code ID ranges for each code and a next code ID table holding next code IDs. Using the configuration, a partial code string is searched for in the search target code string by a first search code string consisting of the data code or the data code string and a first separator code. Next, using a second search code string consisting of first separator codes, the data code or the data code string separated by each of the first separator codes is searched from the found partial code string.

### CROSS-REFERENCE TO RELATED APPLICATIONS

This application is a continuation of PCT/JP2011/000120 filed on January 13.

PCT/JP2011/000120 is based on and claims the benefit of priority of the prior Japanese Patent Application No. 2010-008245, filed on Jan. 18, 2010, the entire contents of which is incorporated herein by reference. The contents of PCT/JP2011/000120 are incorporated herein by reference in their entity.

### BACKGROUND OF THE INVENTION

1. Field of the Invention

This invention is related to code string searches that search with a computer for codes or code strings consisting of bit strings in the same way as character string searches that search for character codes or character code strings consisting of bit strings, especially to code string searches for structured code strings.

2. Description of Related Art

Recently it has become customary to use word processing to create business documents, and by the spread of the internet, the number and size of electronic documents, using character codes consisting of bit strings that can be processed by computers, have grown immensely throughout the world. For this reason, various character string search methods are being developed in order to fetch a necessary document from out of this huge amount of documents using computers.

In these character string search methods it is general practice to prepare an index ahead of time in order to realize fast searches. For example, the method of extracting words from the documents for the index and making an inverted index that associates the name of a document that includes those words for each of those words is well known. This method has the advantages that the size of this inverted index is relatively small, the search is fast, and configuring the index is easy. However there are languages for which words are difficult to extract. And this method has the disadvantage that when a search is made for a set of multiple words it becomes necessary to process word position matches for the document. And a search for an arbitrary string of characters in a single document is also difficult.

And so an index called a suffix array has been developed that enables a search for any character string. The patent reference 1 and non-patent reference 1 below disclose a suffix array and a search method using that array.

FIG. 1A describes an example of previous search methods related to the above suffix array. FIG. 1A shows an example of a character string, character string 10, which is the target of a search. Character string 10 consists of the alphabetic characters A, B, C, E, and the separator character $. The character A is located in character positions 1, 4, and 7 of character string 10. The character B is located in character positions 2 and 5 of character string 10. The character C is located in character positions 6 and 8 of character string 10. The character E is located in character position 3 of character string 10. The separator character $ is located in character position 9, which is the tail end of character string 10.

Also FIG. 1A depicts the suffixes in character position sequence 20, the suffixes in dictionary sequence 20a, and the suffix array 30 which correspond to the character string 10. FIG. 1A further depicts the arrow with a dotted line 81 showing that the suffixes in character position sequence 20 are those of the character string 10 and the arrow with a dotted line 82 showing that the suffixes in dictionary sequence 20a is obtained by sorting the suffixes in character position sequence 20 into dictionary sequence.

Character string 10, as shown in the suffixes in character sequence 20, can be thought to have 9 suffixes as its partial character strings. By sorting suffixes in character position sequence 20, which has suffixes arranged in the character position sequence of the leading character of each suffix, into dictionary sequence, suffixes in dictionary sequence 20a is obtained. At this time, by storing the character position of the leading character of the suffix rearranged in dictionary sequence in an array, suffix array 30 is obtained. By means of this suffix array, the leading character position of a partial character string that matches the pattern of the search character string can be obtained from among the character strings that are the target of the search.

FIG. 1B describes conceptually a character string search using a compressed suffix array in an example of a prior art search method and shows compressed suffix array 50 (a conceptual diagram) associated with search character string 40 and suffix array 30 shown in the description referencing FIG. 1A. In array element number (i) of compressed suffix array 50 (conceptual diagram) is stored the next array element number (j). The next array element number (j) is an array element number of suffix array 30 wherein is stored a character position which has 1 added to the character position stored in array element number (i) of suffix array 30.

By changing the content stored in the array from a character position to a next array element number (j), the values stored in each character group are arranged in ascending order, as shown in the drawing. As a result, because the value stored in each array element need not be the actual next array element number (j) itself but can be an increment on the value of the previous array element number, the bit width of the addresses can be made smaller, and the amount of information can be compressed.

Regarding the concept of a search, FIG. 1B shows the search steps from each of the characters in the illustrated search character string 40 by means of the arrow with a dotted line to array element numbers (i) of compressed suffix array 50 (conceptual diagram) and by means of an arrow between the numbers 3, 6, 9 shown in bold for those array element numbers (i), and the numbers 6, 9 shown in bold in the next array element number (j). In other words, given that from among the array element numbers corresponding to the leading character A in search character string 40, 3, for example, is selected and the next array element number 6 in array element number 3 is the array element number corresponding to the second letter B in the search character string 40, and the next array element number 9 in array element number 6 is the array element number corresponding to the third letter E in the search character string 40, it can be understood that character string 10 that is the target of searches will result in a hit in a search using search character string 40.

Also, structured documents like data in table format exist among documents in electronic format. The patent reference 2 below teaches an art that makes an issue of high-speed searching of data in table format created by ordinary spreadsheet software without increasing the processing load on the computer.
Patent Document 1: JP 3,672,242 B
Patent document 2: JP 2003-114901 A
Non-Patent document 1: Sadakane Kunihiko, “A Note on the Compressed Suffix Arrays”; IEICE technical report, Data engineering; 100 (226), pp. 49-56, 2000 Jul. 19; The Institute of Electronics, Information and Communication Engineers.

### SUMMARY OF THE INVENTION

The purpose of this invention is to provide a method to expand data with a structure like table-format data into code strings and to search those code strings. More often than not searches require a value in a specific column (field) in table-format data to be specified and the data values in the other columns (fields) in the rows (records) with that value stored in that specific column (field) to be obtained. The purpose of this invention is to provide a method that enables searches of the type where data with a structure like table-format data has been expanded into code strings.

By combining the code or code string that expresses the data stored in each cell in a table with the code that expresses the position of that cell, 2-dimension table data can be expanded into 1-dimension code strings. Then, for example by using a compressed suffix array in a code string search, a search can be done for any code string and the size of the array can be reduced. However, to create a compressed suffix array, first it is necessary that suffixes be created from the code strings that are the object of searches and those suffixes be sorted in dictionary sequence, and a suffix array be created, and so the processing time for creating a compressed suffix array from code strings that are the object of searches becomes quite large.

Whereat, the problem that this invention intends to solve is to enable searches of the above type on code strings that have expanded structured data and to devise a structure for index data that can be created faster than previous art and to provide a code string search method that uses that structure.

A code string that has been expanded out of structured data in accordance with this invention, in other words a structured code string, is a code string wherein special kinds of codes are systematically included in the code string. For example, if the data is in a table format, each row in the table can be expanded into code strings consisting of a code or a code string expressing the data in each column, a code expressing that column, and a code expressing the end of each row or a return code (hereinafter called a partial code string). In other words, table-format data is expanded into a structured code string that is a concatenation of partial code strings corresponding to each row (hereinafter this may be simply called a code string).

Furthermore, more generally, a partial code string is a portion demarked not only by a return code but also by a special code in the code string (partial code string separator code). Also, the codes or code strings expressing the data in a partial code string are demarked by a special code (code separator code).

In accordance with this invention, first a code ID that uniquely identifies each and all of the codes located in the code strings that are the object of searches is to be assigned to each and all of those codes in such a way that the range of code IDs does not overlap for any of the values of differing codes (hereinbelow they may simply be called a code if there is no risk of misunderstanding; also conversely to emphasize the fact that they are the values of differing codes they may be called code types). For example, the above code assignment can be realized by repeatedly assigning a code ID in ascending order to each code in the order that they occur in the code string, the value of the first code ID for each code type having a larger value than that of the code IDs assigned until then.

And, in accordance with this invention, a code ID range table holding the range of code IDs for each code, and a next code ID table holding, corresponding to each of the code IDs except a partial code string separator code (this may be called a second separator code), a next ID code, which is a code ID of a code located next to a code whose code ID is the corresponding code ID and holding, as a next code ID, for each of the code IDs of partial code string separator codes, the code ID of a head code in each of the partial code strings related to the partial code string separator codes, are both created and a code string search is implemented using that code ID range table and that next code ID table.

In accordance with the code string search of this invention, first, using a first search code string comprising either a code that expresses data (hereinafter this may be called a data code) or a data code string and a code separator code (this may be called a first separator code), the code string to be searched is searched for a partial code string that includes the first search code string. Next, using a second search code string comprising the code separator code, data codes or data code strings demarked by the code separator code are obtained from the retrieved partial code strings.

In accordance with the code string search of this invention for searching the code string to be searched by means of the first search code string, the ranges of the code IDs for the codes comprising the search code string are read out from the code ID range table for the search target code string, and the stored next code ID corresponding to a code ID included in the code ID range for the first code in the read-out search code string is read out from the next code ID table while the next code IDs stored corresponding to that next code ID are successively read out from the next code ID table and it is verified whether the next code ID read out from the next code ID table is included in the range of code IDs of the next codes read out from the code ID range table.

Because when the above verification succeeds up to the last code in the first search code string, a partial code string exists that includes the same code string as the first search code string, and using the second search code string, a code or a code string demarked by the code separator code is obtained from that partial code string, and are output as a search result output code or code string in compliance with the second search code string.

In accordance with this invention, because a search can be implemented using a code ID range table with a simple structure and a next code ID table, it is not necessary to create a suffix array, and the processing burden for creating a computer index can be reduced. Also, the code or code string separated by the code separator code that is specified by the second search code string can be obtained from the partial code string including codes or code strings separated by the code separator code that is specified by the first search code string.

### BRIEF DESCRIPTION OF THE DRAWINGS

FIG. 1A is a drawing describing an example of previous search methods related to a suffix array.

FIG. 1B is a drawing describing a compressed suffix array in an example of previous search methods.

FIG. 2A is a drawing describing conceptually a structured code string and its partial code strings in one embodiment of this invention.

FIG. 2B is a drawing describing an example of an index data structure in one embodiment of this invention.

FIG. 2C is a drawing describing conceptually a search for a partial code string by means of the first search code string in one embodiment of this invention.

FIG. 2D is a drawing describing conceptually a partial code string search using the second search code string in the code string search in one embodiment of this invention.

FIG. 3 is a drawing describing an exemplary hardware configuration in one embodiment of this invention.

FIG. 4 is a drawing describing an example of the general flow of processing that creates index data in one embodiment of this invention.

FIG. 5A is a drawing describing an example of the processing flow for enumerating the number of occurrences of each code type of the codes included in the code string that is the target of searching.

FIG. 5B is a drawing describing an example of the processing flow for setting the code ID range for each code type based on the number of occurrences.

FIG. 5C is a drawing describing an example of the processing flow for completing a next code ID table based on the codes included in the search target code string.

FIG. 6 is a drawing describing an example of the processing flow to set a code ID in the next code ID table.

FIG. 7A is a drawing describing an example of the processing flow in the prior stage of searching for a code string in one embodiment of this invention.

FIG. 7B is a drawing describing an example of the processing flow in the latter stage of searching for a code string in one embodiment of this invention.

FIG. 8 is a drawing describing an example of the processing flow to determine whether the search code string is included in the search target code string.

FIG. 9 is a drawing describing an example of the processing flow to obtain the head code ID in a partial code string that includes the first search code string.

FIG. 10 is a drawing describing an example of the processing flow to output successively output code strings using the second search code string.

FIG. 11 is a drawing describing an example of the processing flow to obtain an output code string from a partial code string using the second search code string.

FIG. 12 is a drawing describing an example of the processing flow to convert the code ID into a code.

FIG. 13 is a drawing describing an example of a function block configuration for creating the data structure for an index in one embodiment of this invention.

FIG. 14A is a drawing describing an example of a function block configuration for a code string search apparatus in one embodiment of this invention.

FIG. 14B is a drawing describing an example of a function block configuration for the first search execution part in one embodiment of this invention.

FIG. 14C is a drawing describing an example of a function block configuration for the second search execution part in one embodiment of this invention.

Hereinbelow, preferable embodiments of this invention are described while referencing the drawings.

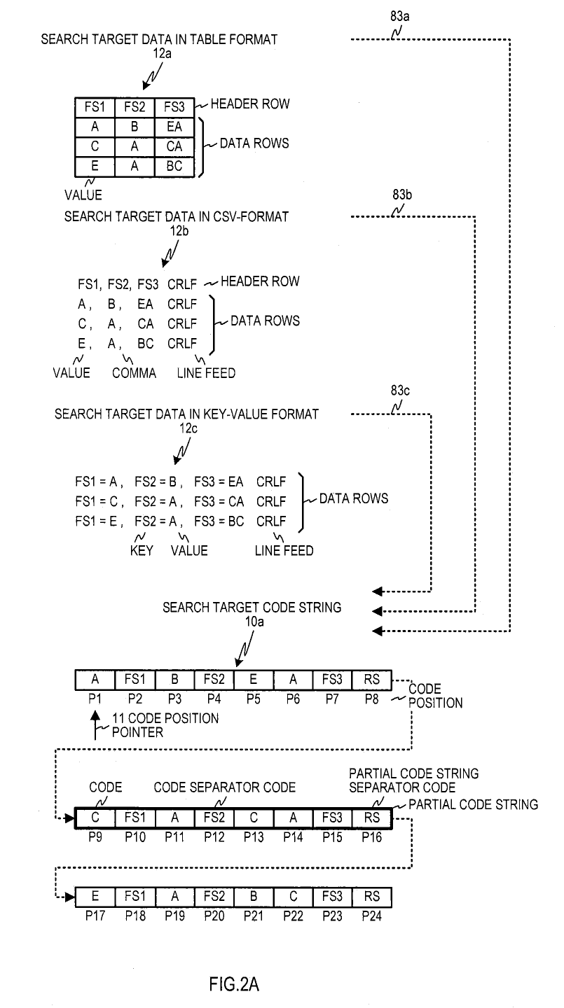

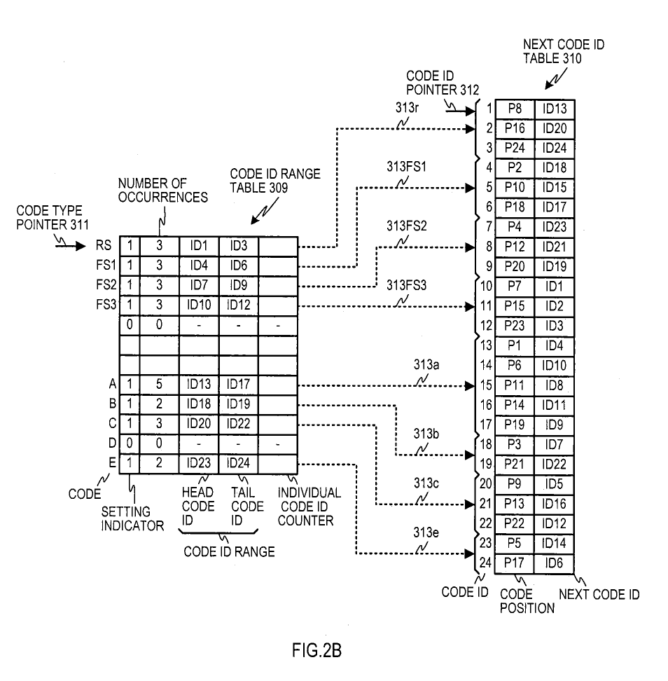

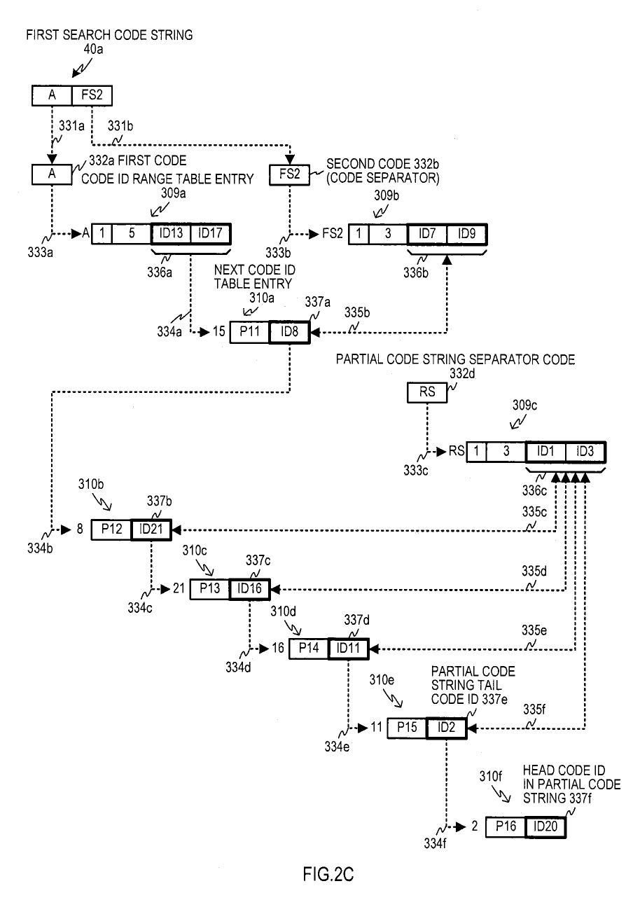

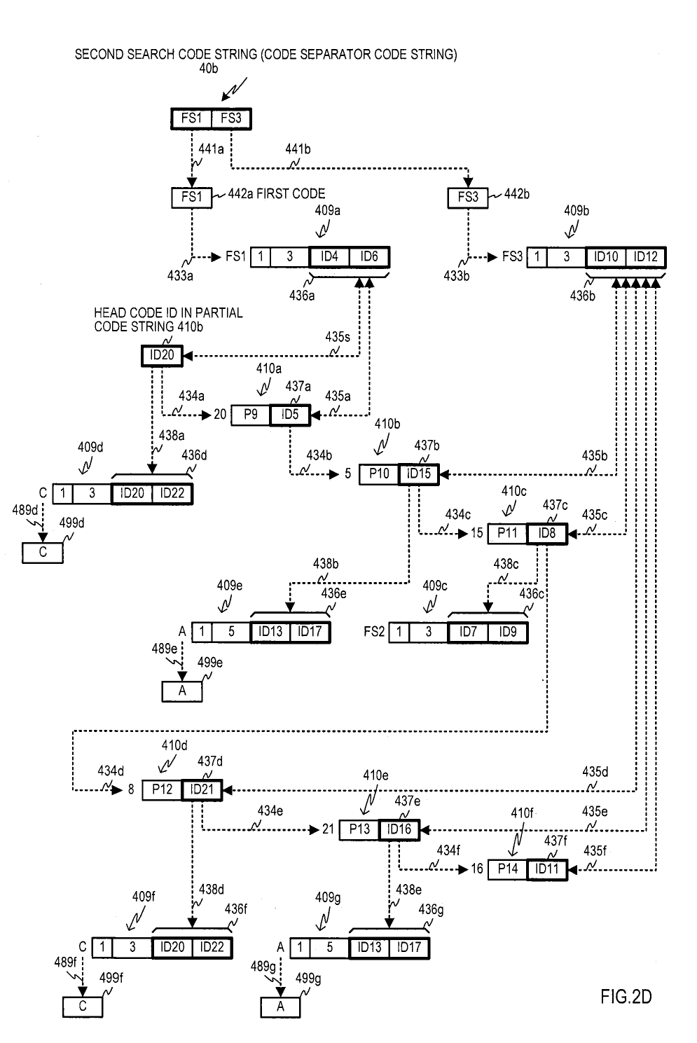

First an overview of the search method in one embodiment of this invention is described referencing FIG. 2A to FIG. 2D.

FIG. 2A is a drawing describing conceptually a structured code string and its partial code strings in one embodiment of this invention. FIG. 2A shows, as examples of data to be searched that has a structured format, examples of data in table format 12a, of data in csv-format 12b, of data in key-value format 12c, and of the search target code string 10a that has their data expanded into code strings. The search target code string 10a is used to create the index data.

The data in table format 12a shown in the example is configured from a header row consisting of FS1, FS2, and FS3 that express each of the columns in the table and data rows holding the values A, B, and EA in the first row, the values C, A, and CA in the second row, and the values E, A, BC in the third row.

Then, as shown by the arrow with a dotted line 83a, the data in table format 12a is converted into the search target code string 10a by associating the values in the column header with code separator codes, by associating the data values with codes or code strings, and by associating the rows with a partial code string separator code. Also the code separator codes are denoted by the values in the column header. And the partial code string separator code is denoted by RS.

Thus the search target code string 10a shown in the example is configured of the 24 character codes A, FS1, B, FS2, E, A, FS3, RS, C, FS1, A, FS2, C, A, FS3, RS, E, FS1, A, FS2, B, C, FS3, and RS, and is demarked into 3 partial code strings by the partial code string separator code RS. The P1 to P24 depicted below each of those character codes indicate the position of the code in search target code string 10a. The code position pointer 11 is a pointer that indicates the position of a code in search target code string 10a and in the example in the drawing it points to code position P1. A code ID range table and a next code ID table are created as the index data for any code string that is the target of a search.

Both the csv-format data 12b and the key-value-format data 12c can be converted into search target code string 10a just like table-format data 12a as shown by the arrow with a dotted line 83b and the arrow with a dotted line 83c. In the example in the drawing, the data values in csv-format data 12b and key-value-format data 12c are the same as the data values in table-format data 12a.

In csv-format data 12b, the names for the columns separated by commas in the header row are the same as the FS1, FS2, FS3 that expresses each column in the table for table-format data 12a and they are converted into code separator codes. Also the return code CRLF is converted into the partial code string separator code RS.

In key-value-format data 12c, the FS1, FS2, FS3 that express each column in the table for table-format data 12a are used to denote the keys notation, and they are converted into code separator codes. Also the return code CRLF is converted into the partial code string separator code RS.

FIG. 2B shows an example of an index data structure for a code string search and exemplifies a code ID range table 309 and a next code ID table 310 generated in correspondence to the search target code string 10a shown in FIG. 2A.

The entries of the code ID range table 309 are created for each code type of the differing codes that occur in the search target code string, which is the object for making index data. As is shown on the left side of the code ID range table 309 in the example shown in the drawing, the search target code string consisting of the partial code string separator code RS (hereinafter this may be called code RS), the code separator codes FS1, FS2, and FS3 (hereinafter each of these may be called like code FS1), and codes A to E is the object for making the index data, and an entry is made corresponding to each code. The code type pointer 311 is a pointer to the entries in the code ID range table 309, and in the example in the drawing points to the entry corresponding to partial code string separator code RS.

Also, because each code is composed of a bit string, each code holds a value that can be expressed by the bit values of that bit string. Thus, it is clear that a position of an entry corresponding to each code in code ID range table 309 can be associated with the value of each such code. In other words, the value taken by the code type pointer 311 can be made the code itself. Consequently, in the description below, an entry corresponding to a given code may be expressed as an entry being pointed to by that code.

As shown in the information beneath the code ID range table 309, an entry in the code ID range table 309 consists of a setting indicator, a number of occurrences, a head code ID, a tail code ID, and an individual code ID counter. The setting indicator shows with a 0 or 1 whether that code occurs in the search target code string, and in the example in the drawing, because the code D does not occur in search target code string 10a, only the entry for code D has a 0, and all the other entries have a 1. The number of occurrences is the number of times that code occurs in the search target code string, and in the example in the drawing, corresponding to search target code string 10a, 5, 2, 3, 0, and 2 are stored for the codes A to E, and 3 is stored for each of code RS and code FS1 to code FS3.

The head code ID and the tail code ID indicate the range for that code ID for each code. The code ID is assigned in the order of appearance of each unique code in the search target code string in order that there be no overlap between codes, and in the example shown in the drawing, because the number of occurrences for code RS is 3, it has the range of ID 1 to ID 3, and because the number of occurrences for the next code FS1 is 3, it has the range of ID 4 to ID 6. Hereinbelow, in the same way, code FS2 has ID 7 to ID 9, code FS3 has ID 10 to ID 12, code A has ID 13 to ID 17, code B has ID 18 to ID 19, code C has ID 20 to ID 22, and code E has ID 23 to ID 24.

Also, although it preferable that the value of ID 1 and so forth is an integer value beginning concretely from 1, it is not limited to that technique and it is sufficient that the ID ranges for each code be differentiated. Also, although the code ID range is expressed by a head code ID and a tail code ID in the example in the drawing, it can be expressed by enumerating all the code IDs if one does not mind that codes have a variable data length.

An individual code ID counter is a counter needed when a next code ID table is to be created at the same time that a code ID range table is being created, and it is not necessary as index data. Thus it can be set up as a counter separate from that of the code ID range table, for each of the differing code types.

An entry in the next code ID table 310 is created for each code ID assigned to a code in search target code string 10a. As shown on the left side of next code ID table 310, in the example shown in the drawing, entries are created corresponding to code ID 1 to code ID 24. Each entry consists of the items code position and next code ID. Code ID pointer 312 is a pointer pointing to an entry in next code ID table 310, and in the example in the drawing it points to ID 1.

The code position in the entry for each code ID is a code position that is the position of the code with that code ID in search target code string 10a, and in the example shown in the drawing P8 is stored for ID 1, P16 is stored for ID 2, P24 is stored for ID 3, P2 is stored for ID 4, P10 is stored for ID 5, P18 is stored for ID 6, P4 is stored for ID 7, and P12 is stored for ID 8. Similarly, P20 is stored for ID 9, P7 is stored for ID 10, P15 is stored for ID 11, P23 is stored for ID 12, P1 is stored for ID 13, P6 is stored for ID 14, P11 is stored for ID 15, P14 is stored for ID 16, P19 is stored for ID 17, P3 is stored for ID 18, P21 is stored for ID 19, P9 is stored for ID 20, P13 is stored for ID 21, P22 is stored for ID 22, P5 is stored for ID 23, and P17 is stored for ID 24.

As shown by the dotted line of arrow 313r in the drawing, the first to third entries in next code ID table 310 correspond to the code RS. Also, as shown by the dotted line of arrows 313FS1, 313FS2 and 313FS3, the fourth to sixth, the seventh to ninth, and the tenth to twelfth entries correspond to codes FS1, FS2 and FS3. Similarly, as shown by the dotted-line arrow 313a in the drawing, the 13th to 17th entries correspond to code A, as shown by the dotted-line arrow 313b, the 18th, 19th entries correspond to code B, as shown by the dotted-line arrow 313c, the 20th to 22nd entries correspond to code C, and as shown by the dotted-line arrow 313e, the 23rd and 24th entries correspond to code E.

The next code ID for each code ID entry is the code ID for the code located next in search target code string 10a after the code for that code ID entry. In the example shown in the drawing, for ID 1 the stored next code ID is ID 13, for ID 2 the stored next code ID is ID 20, for ID 3 the stored next code ID is ID 24, for ID 4 the stored next code ID is ID 18, for ID 5 the stored next code ID is ID 15, for ID 6 the stored next code ID is ID 17, for ID 7 the stored next code ID is ID 23, and for ID 8 the stored next code ID is ID 21. Thereinafter, similarly, for ID 9 the stored next code ID is ID 19, for ID 10 the stored next code ID is ID 1, for ID 11 the stored next code ID is ID 2, for ID 12 the stored next code ID is ID 3, for ID 13 the stored next code ID is ID 4, for ID 14 the stored next code ID is ID 10, for ID 15 the stored next code ID is ID 8, for ID 16 the stored next code ID is ID 11, for ID 17 the stored next code ID is ID 9, for ID 18 the stored next code ID is ID 7, for ID 19 the stored next code ID is ID 22, for ID 20 the stored next code ID is ID 5, for ID 21 the stored next code ID is ID 16, for ID 22 the stored next code ID is ID 12, for ID 23 the stored next code ID is ID 14, and for ID 24 the stored next code ID is ID 6. Also the ID 13, ID 20, and ID 24 that are the code IDs, respectively, for code A, code C, code E that are the first codes in each of the partial code strings are stored for the code RS (code ID 1, ID 2, ID 3) that is the last code in each partial code string in search target code string 10a.

Next code ID table 310 keeps, as index data, the fact that 2 codes, expressed in code IDs, have a contiguous position relationship in the search target code string. When next code ID table 310 is compared with compressed suffix array 50 in the example of previous art shown in FIG. 2B, whereas, in compressed suffix array 50, the next array element number for each character is sorted, in next code ID table 310, the code position is sorted for the code type of each differing code. Thus if a successive search is made for the same code, the cache effect can be expected to provide faster processing.

FIG. 2C is a drawing describing conceptually a search for a partial code string by means of the first search code string in one embodiment of this invention. The first search code string is a code string consisting of the code or code string expressing the data and the code separator code. In a search using the first search code string, partial code strings that include the first search code string are obtained. More concretely, in the example shown below, the code ID of the first code in the above-noted partial code string is obtained. In the description hereinbelow, when there is no danger of confusing the code ID of the first code with the head code ID in the code ID range table, that first code may at times be called the head code ID.

The concept of a search by means of the first search code string is described using the search target code string 10a, illustrated in FIG. 2A, as the search target code string and the first search code string 40a shown in FIG. 2C as the first search code string. Code ID range table 309 and next code ID table 310 are assumed to have been created for search target code string 10a.

As shown in the drawing, from the head of first search code string 40a, the data code A and the separator code FS2 are located. Then as shown in the drawing by dotted-line arrow 331a, code A, which is the first code, code 332a, is read out, and, as shown by dotted-line arrow 333a, entry 309a corresponding to code A in code ID range table 309 is read out. Then, as shown by dotted-line arrow 334a, next code ID table entry corresponding to a code ID included in ID range 336a—in the example in the drawing, this is entry 310a corresponding to the code ID 15—is read out from next code ID table 310.

Next, as shown by dotted-line arrow 331b, code FS2, which is the second code, code 332b, is read out, and as shown by dotted-line arrow 333b, entry 309b corresponding to code FS2 in code ID range table 309 is read out. Then as shown by the bidirectional dotted-line arrow 335b, a determination is made whether ID 8, which is next code ID 337a of entry 310a that corresponds to code ID 15 read-out from next code ID table 310 is included in the code ID range 336b (ID 7 to ID 9) of entry 309b, which corresponds with the read-out code FS2. In the example shown in the drawing, the result of the determination is “yes”. This means that the sequence code A, code FS2 exists in search target code string 10a.

Next, the code ID of the head code in the partial code string that includes the sequence code A, code FS2 is obtained. Then, as further shown by dotted-line arrow 334b, ID 21, which is the next code ID 337b in entry 310b corresponding to ID 8 in next code ID 337a, is read out. This time, as shown by dotted-line arrow 333c, the code RS that is the partial code string separator code 332d is read out and entry 309c corresponding to the code RS in code ID range table 309 is read out. Then, as shown by the bidirectional dotted-line arrow 335c, a determination is made whether ID 21, which is the next code ID 337b in entry 310b corresponding to ID 8 read out from next code ID table 310 is included in the code ID range 336c (ID 1 to ID 3) of entry 309c, which corresponds with the read-out code RS.

Because the result of the above noted determination is negative, as shown by the dotted-line arrow 334c, ID 16 that is the next code ID 337c in entry 310c corresponding to ID 21 that is the next code ID 337b in entry 310b is read out, and as shown by the bidirectional dotted-line arrow 335d, a determination is made whether it is included in the code ID range for code RS. Because the result of this determination is also negative, thereinafter, in the same way, as shown by the dotted-line arrow 334d, ID 11 that is the next code ID 337d in entry 310d corresponding to ID 16 that is the next code ID 337c in entry 310c is read out and as shown by the bidirectional dotted-line arrow 335e, a determination is made whether it is included in the code ID range for code RS.

Because the result of this determination is also negative, next, as shown by the dotted-line arrow 334e, ID 2 that is the next code ID 337e in entry 310e corresponding to ID 11 that is the next code ID 337d in entry 310d is read out, and as shown by the bidirectional dotted-line arrow 335f, a determination is made whether ID 2 that is the next code ID 337e in entry 310e corresponding to code ID 11 read out from next code ID table 310 is included in the code ID range 336c (ID 1 to ID 3) for entry 309c that corresponds to read-out code RS. In the example shown in the drawing, the result is the determination is “yes”. In other words, it can be understood that ID 2 is the code ID for the tail code (tail code ID) of the partial code string.

At this point, as shown by the dotted-line arrow 334f, ID 20 that is the next code ID 337f in entry 310f corresponding to ID 2 that is the next code ID 337e in entry 310e is read out as the head code ID for the partial code string. Also, the code ID of the tail code (tail code ID) for the partial code string can also be output to identify the partial code string that is found.

FIG. 2D is a drawing describing conceptually a partial code string search using the second search code string in the code string search in one embodiment of this invention. The second search code string is a code string consisting of the code separator code. A search using the second search code string obtains the code or code string demarked by the code separator code specified in the second search code string, within the partial code string obtained by the search using the first search code string.

ID 20 is taken to be obtained as the code ID for the head code of the partial code string in the search target code string 10a, using the first search code string 40a shown in the example in FIG. 2C. Hereinbelow, taking the search code string to be the second search code string 40b shown in FIG. 2D, the concepts of a search using the second search code string is described.

As shown in the drawing, the code separator codes FS1, FS3 are disposed in the second search code string 40b from its head. At that point, as shown by the dotted-line arrow 441a, the code FS1 that is the first code 442a is read out, and as shown by the dotted-line arrow 433a, the entry 409a that corresponds to code FS1 in the code ID range table 309 is read out.

Also, the ID 20 that is the code ID of the head code in the partial code string obtained by the search for the first search code string shown in FIG. 2C is set in the head code ID 410b in the partial code string. The ID 20 that is the head code ID is the first search start code ID for the search by the second search code string. Then, as shown by the bidirectional dotted-line arrow 435s, a determination is made whether the ID 20 is included in the code ID range 436a (ID 4 to ID 6) for entry 409a in the code ID range table 309 that corresponds to the read-out code FS1.

Because the above determination is negative and, as shown by the dotted-line arrow 438a, ID 20 is found to be included in the code range 436d for the entry 409d in the code ID range table 309, then, as shown by the dotted-line arrow 489d, the code C corresponding to entry 409d is set in the temporary storage area 499d as a prospective search answer.

Also, as shown by the dotted-line arrow 434a, the entry 410a in the next code ID table 310 corresponding to the ID 20 set in the head code ID 410b in the partial code string is read out. Then, as shown by the bidirectional dotted-line arrow 435a, a determination is made whether the ID 5 that is the next code ID 437a for that entry 410a is included in the code ID range 436a (ID 4 to ID 6) for entry 409a in the code ID range table 309 that corresponds to the read-out code FS1.

Because the above determination is positive, the code C set in the temporary storage area 499d becomes the output code to be output from the prospective search answer as the search answer.

Continuing, as shown by the dotted-line arrow 434b, the entry 410b in the next code ID table 310 corresponding to the ID 5 that is the next code ID 437a for entry 410a is read out and the ID 15 that is the next code ID 437b for entry 410b is obtained as the next search start code ID.

Because the code C is obtained as the output code demarked by the code separator code FS1 by the above processing, next, as shown by the dotted-line arrow 441b, the code FS3 that is the second code 442b in the second search code string 40b is read out and as shown by the dotted-line arrow 433b, the entry 409b that corresponds to code FS3 in the code ID range table 309 is read out. Then, as shown by the bidirectional dotted-line arrow 435b, a determination is made whether the ID 15 that is the next code ID 437b for the entry 410b previously read out is included in the code ID range 436b (ID 10 to ID 12) for entry 409b in the code ID range table 309 that corresponds to the read-out code FS3.

Because the above determination is negative and, as shown by the dotted-line arrow 438b, the ID 15 obtained as the next code ID 437b for entry 410b is seen to be included in the code range 436e for entry 409e in code ID range table 309, then, as shown by the dotted-line arrow 489e, the code A corresponding to entry 409e is set in the temporary storage area 499e as a prospective search answer.

Also, as shown by the dotted-line arrow 434c, the entry 410c in the next code ID table 310 corresponding to the ID 15 found to be the next code ID 437b for entry 410b is read out. Then, as shown by the bidirectional dotted-line arrow 435c, a determination is made whether the ID 8 that is the next code ID 437c for the entry 410c is included in the code ID range 436b (ID 10 to ID 12) for entry 409b in the code ID range table 309 that corresponds to the read-out code FS3.

Because the above determination is negative, as shown by the dotted-line arrow 438c, the ID 8 obtained as the next code ID 437c for entry 410c is found to be included in the code range 436c for the entry 409c in the code ID range table 309.

But because the code FS2 corresponding to entry 409c is not a data code, the code A that has been set in the temporary storage area 499e is cleared and is not made an output code for the search answer.

Continuing, as shown by the dotted-line arrow 434d, the entry 410d corresponding to the ID 8 that is the next code ID 437c for entry 410c is read out. Then, as shown by the bidirectional dotted-line arrow 435d, a determination is made whether the ID 21 that is the next code ID 437d for that entry 410d is included in the code ID range 436b (ID 4 to ID 6) for entry 409b in the code ID range table 309 that corresponds to the read-out code FS3.

Because the above determination is negative and, as shown by the dotted-line arrow 438d, ID 21 obtained as the next code ID 437d for entry 410d is found to be included in the code range 436f for the entry 409f in the code ID range table 309, then, as shown by the dotted-line arrow 489f the code C corresponding to entry 409f is set in the temporary storage area 499f as a prospective search answer.

Also, as shown by the dotted-line arrow 434e, the entry 410e in the next code ID table 310 corresponding to the ID 21 found as the next code ID 437d for entry 410d is read out. Then, as shown by the bidirectional dotted-line arrow 435e, a determination is made whether the ID 16 that is the next code ID 437e for that entry 410e is included in the code ID range 436b (ID 10 to ID 12) for entry 409b in the code ID range table 309 that corresponds to the read-out code FS3.

Because the above determination is negative and, as shown by the dotted-line arrow 438e, ID 16 obtained as the next code ID 437e for entry 410e is found to be included in the code range 436g for the entry 409g in the code ID range table 309, then, as shown by the dotted-line arrow 489g, the code A corresponding to entry 409g is set in the temporary storage area 499g as a prospective search answer.

Furthermore, as shown by the dotted-line arrow 434f, the entry 410f in the next code ID table 310 corresponding to the ID 16 found to be the next code ID 437e for entry 410e is read out. Then, as shown by the bidirectional dotted-line arrow 435f, a determination is made whether the ID 11 that is the next code ID 437f for that entry 410f is included in the code ID range 436b (ID 10 to ID 12) for entry 409b in the code ID range table 309 that corresponds to the read-out code FS3.

Because the above determination is positive, the code string CA consisting of the code C and the code A set in temporary storage areas 499f and 499g becomes the output code string for the search answer.

By doing the above, a code string search in accordance to one embodiment of this invention is implemented.

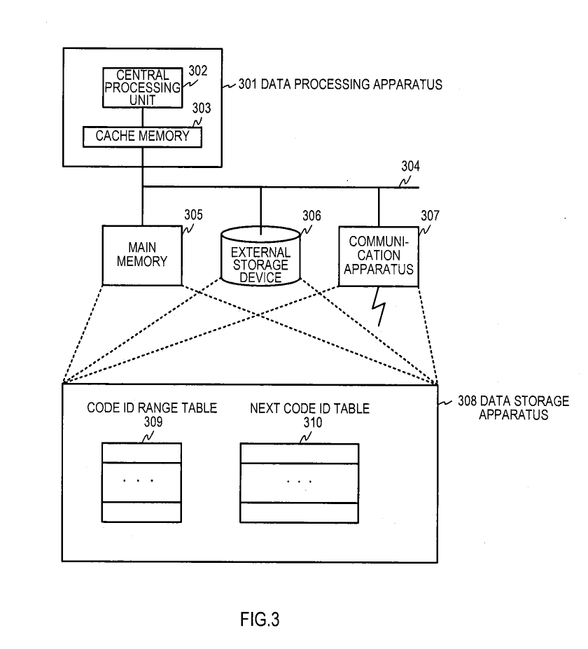

FIG. 3 is a drawing describing an exemplary hardware configuration in one embodiment of this invention.

Search processing and index creation processing are implemented with the code string search apparatus and the index data creation apparatus of the present invention by a data processing apparatus 301 having at least a central processing unit 302 and a cache memory 303, and a data storage apparatus 308. The data storage apparatus 308, which has the code ID range table 309 and the next code ID table 310, can be implemented in the main memory 305 or an external storage device 306, or alternatively, by using a remotely disposed apparatus connected via a communication apparatus 307.

In the example shown in FIG. 3, although the main memory 305, the external storage device 306, and the communication apparatus 307 are connected to the data processing apparatus 301 by a single bus 304, there is no restriction to this connection method. The main memory 305 can also be disposed within the data processing apparatus 301.

Also, although it is not particularly illustrated, a temporary memory area can of course be used to enable various values obtained during processing to be used in subsequent processing. In the descriptions below, the values stored or set in a temporary memory area may be called by the name of that temporary memory area.

Next, the processing to create index data in one embodiment of this invention is described.

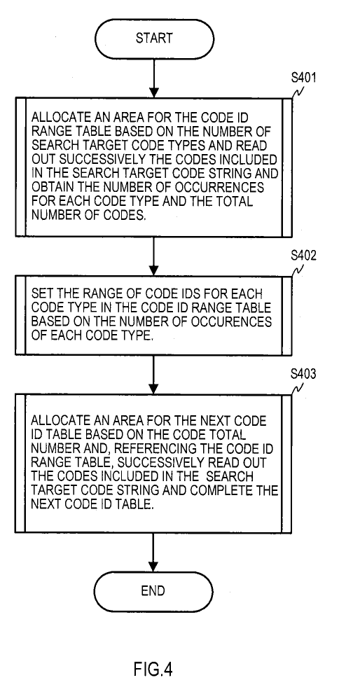

FIG. 4 is a drawing describing an example of the general flow of processing that creates index data in one embodiment of this invention.

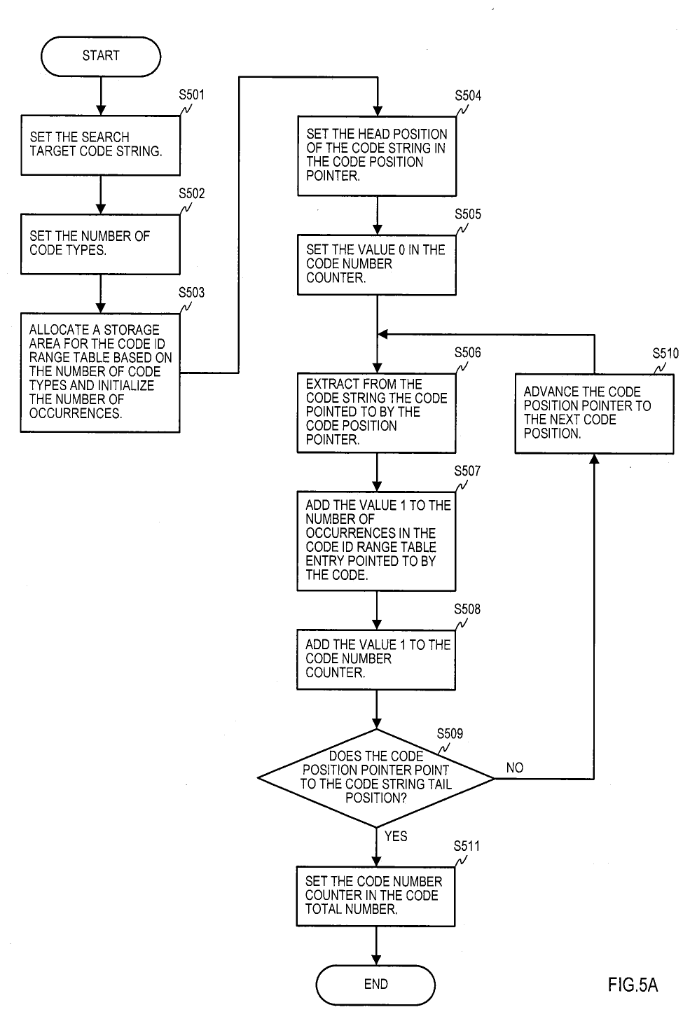

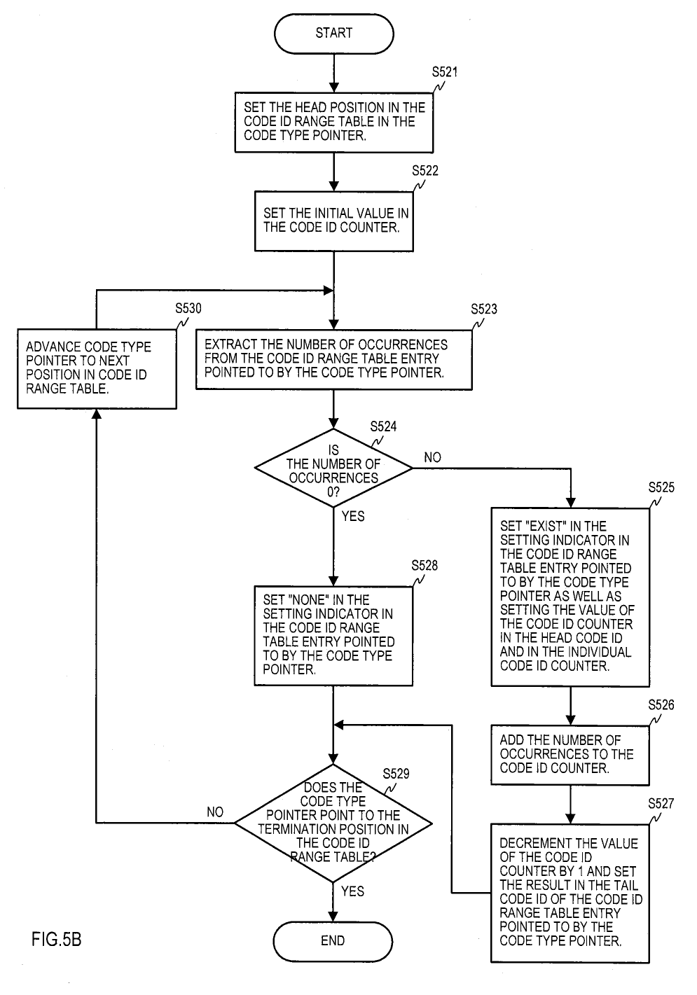

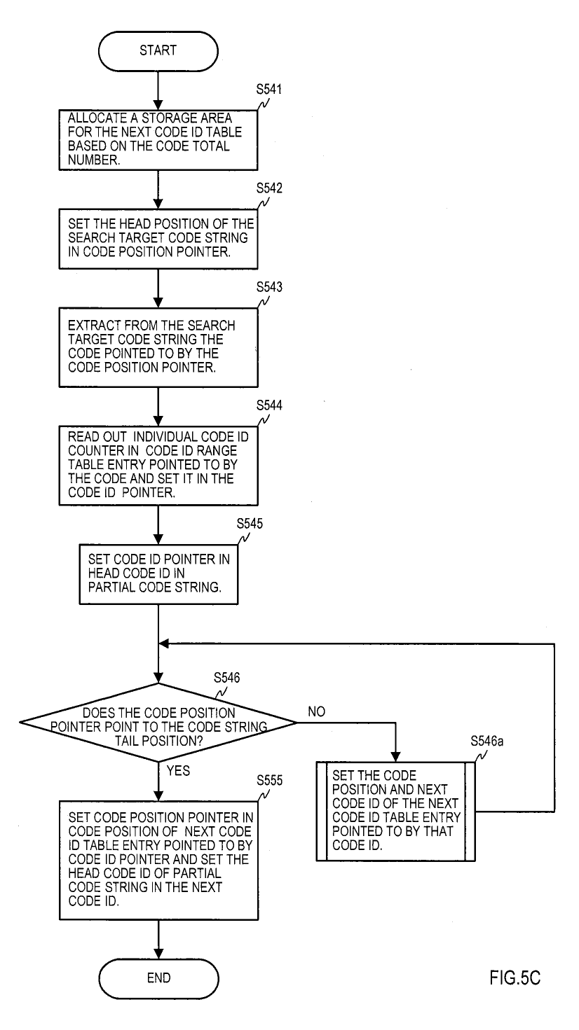

First, in step S401, an area for the code ID range table is allocated based on the number of search target code types and at the same time the codes included in the search target code string are successively read out and the number of occurrences of each read-out code type and the total number of codes are obtained. Details on the processing of step S401 are described later referencing FIG. 5A.

Next at step S402, the range of the code IDs for each code type is set in the code ID range table based on the number of occurrences of each code type. Details on the processing of step S402 are described later referencing FIG. 5B.

Next at step S403, an area for the next code ID table is allocated based on the total number of codes, and the codes included in the search target code string are successively read out referencing the code ID range table, then the next code ID table is completed, and processing is terminated. Details on the processing of step S403 are described later referencing FIG. 5C.

FIG. 5A shows an example of the detailed processing flow for step S401 shown in FIG. 4 and is a drawing describing an example of the processing flow for enumerating the number of occurrences of each code type of the codes included in the search target code strings.

As shown in the drawing, in step S501, a search target code string is set. Setting the search target code string means that one code string is read out from the set of code strings that are the object of searches stored in the data storage apparatus, and is set in an unillustrated search target code string setting area. Also, the above search target code string setting area is one of “temporary storage areas used to enable various values obtained during processing to be used in subsequent processing” described above. In the description hereinbelow, instead of an expression like “setting in an unillustrated search target code string setting area”, expressions such as “set as the search target code string” or more simply “set the search target code string” may be used. The same also applies to temporary data other than a search target code string.

Next, in step S502, the number of code types is set. The number of code types is determined by the code system, and it is assumed to be provided beforehand. Next, proceeding to step S503, a storage area for the code ID range table is allocated based on the number of code types set in step S502, and the number of occurrences is initialized with 0. Continuing, at step S504, the leading position of the code string set at step S501 is set in the code position pointer, and at step S505 the value 0 is set in the code number counter. The above processing of step S501 to step S505 is initialization processing.

Following the initialization processing, proceeding to step S506, the code pointed to by the code position pointer is extracted from the code string. Next, at step S507, the value 1 is added to the number of occurrences for the entry in the code ID range table corresponding to the code type of the extracted code (hereinafter, this may be called the code ID range table entry pointed to by the code), and at step S508, 1 is added to the code number counter, and processing proceeds to step S509.

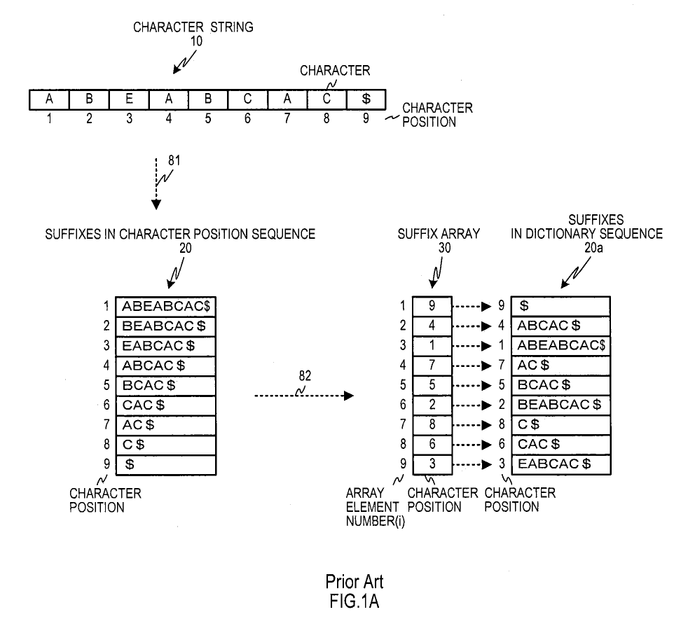

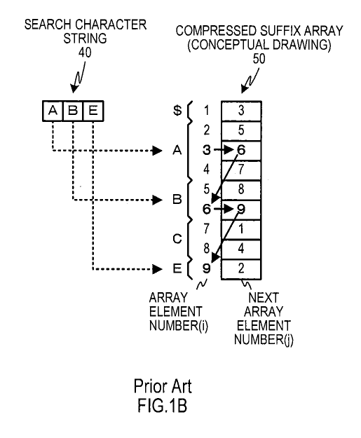

At step S509, a determination is made whether the code position pointer is at the tail position of the code string, and if it is not the tail position, at step S510, the code position pointer is advanced to the next position and processing returns to step S506. If the code position pointer is at the tail position of the code string, at step S511 the code number counter is set in the code total number, and processing is terminated. In the above determination whether the code position pointer is at the tail position of the code string in step S509, a separator character can be used as shown, for example, in FIG. 1A.

By means of the above processing, the number of occurrences in the code ID range table is set as well as the code total number.

FIG. 5B shows an example of the detailed processing flow for step S402 shown in FIG. 4 and is a drawing describing an example of the processing flow for setting the code ID range for each code type based on the number of occurrences set by the processing shown in FIG. 5A.

First, in step S521, the head position in the code ID range table is set in the code type pointer, and next, in step S522, an initialization value is set in the code ID counter. Next, proceeding to step S523, the number of occurrences is extracted from the code ID range table entry pointed to by the code type pointer, and at step S524, a determination is made whether the extracted number of occurrences is 0.

If the number of occurrences is not 0, at step S525, “Exist” is set in the setting indicator in the code ID range table entry pointed to by the code type pointer as well as setting the value of the code ID counter in the head code ID and in the individual code ID counter. The individual code ID counter is used to create the next code ID table described below. The head code ID is set as the initial value for the code ID for each code type.

Next at step S526, the number of occurrences is added to the code ID counter, and at step S527, the value of code ID counter decremented by 1 is set in the tail code ID of the code ID range table entry pointed to by the code type pointer, and processing proceeds to step S529.

Otherwise, if the determination in step S524 is that the number of occurrences is 0, at step S528, “None” is set in the setting indicator in the code ID range table entry pointed to by the code type pointer, and processing proceeds to step S529.

At step S529, a determination is made whether the code type pointer is at the termination position of the code ID range table, and if it is not the termination position, at step S530, the code type pointer is advanced to the next code type position in the code ID range table and processing returns to step S523. If it is the termination position, because the setting of the code ID range table is completed, processing is terminated.

FIG. 5C is a drawing showing an example of the detailed flow of the processing in step S403 shown in FIG. 4 and describes the processing flow for completing a next code ID table based on the codes included in the search target code string. The processing flow shown in FIG. 5C is configured from the initialization processing of step S541 to step S545, the processing loop that sets the values in the next code ID table in the position sequence of the codes in the search target code string consisting of step S546 and step S546a, and the after processing of step S555.

First, at step S541, a storage area for the next code ID table is allocated based on the code total number obtained by the processing shown in FIG. 5B, and at step S542, the head position in the search target code string is set in the code position pointer. Next, at step S543, the code pointed to by the code position pointer is extracted from the search target code string, and at step S544, the individual code ID counter in the code ID range table entry pointed by the code is read out and set in the code ID pointer. Next, at step S545, the code ID pointer is set in the head code ID in partial code string, and processing proceeds to step S546.

For the search target code string 10a shown in FIG. 2A, the initialization processing of step S541 to step S545 above sets P1 in the code position pointer, sets A in the code, sets ID 13 in the code ID pointer, and sets ID 13 in the head code ID in the partial code string.

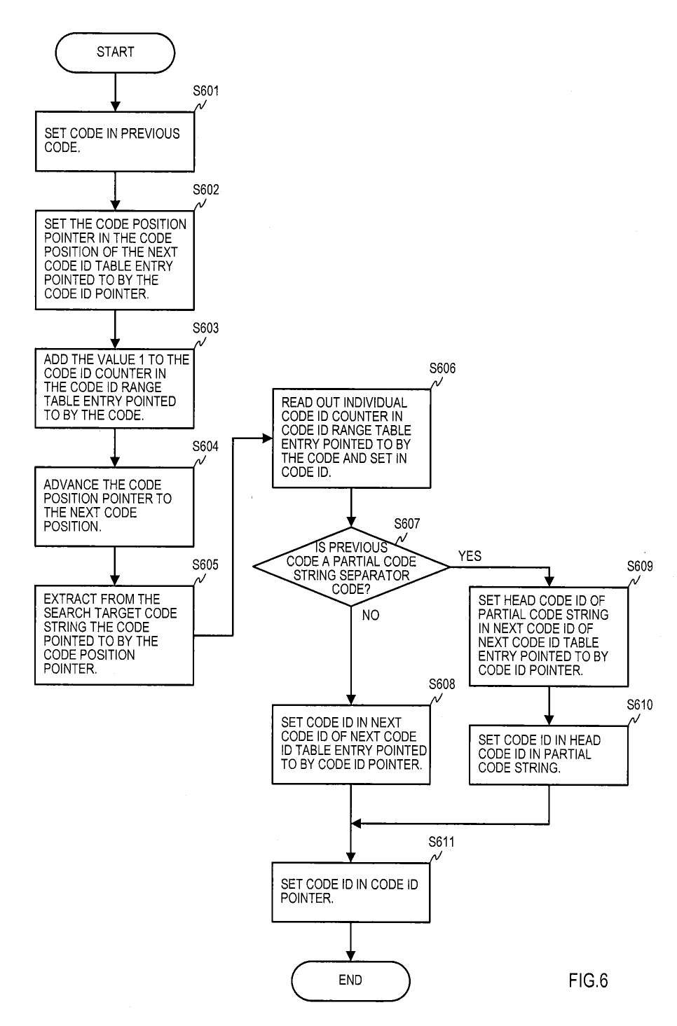

At step S546, a determination is made whether the code position pointer is at the tail position of the search target code string, and if it is not at the tail position, processing proceeds to step S546a, and the code position and next code ID of the next code ID table entry pointed to by that code ID are set and processing returns to step S546. The code position pointer is updated in the processing of step S546a. Details of the processing in step S546a is described below referencing FIG. 6.

The processing of the above step S546a is repeated until the code position pointer points to the tail position in the search target code string, and when the code position pointer points to the tail position in the search target code string, processing branches to step S555. At step S555, in order to set the next code ID table entry corresponding to the code ID for the code positioned at the end of the search target code string, the code position pointer is set in the code position in the next code ID table entry pointed to by the code ID pointer, and the head code ID in the partial code string is set in the next code ID, and processing is terminated. In the processing of step S546a, the code ID pointer is updated for each code in the search target code string, and the head code ID in the partial code string is updated every time the setting of one of the partial code strings is completed.

FIG. 6 is a drawing describing an example of the processing flow to set the code position in the next code ID table entry pointed to by the code ID and the next code ID, and it describes in detail the processing in step S546a shown in FIG. 5C.

As shown in the drawing, first in step S601, a code is set in the previous code. Then in step S602, the code position pointer is set in the code position in the next code ID table entry pointed to by the code ID pointer.

Next, at step S603, 1 is added to the individual code ID counter in the next code ID table entry pointed to by the code extracted at step S543 or at step S605 described below, and at step S604, the code position pointer is advanced to the next code position.

Next, in step S605, the code pointed to by the code position pointer is extracted from the search target code string, and at step S606, the individual code ID counter in the next code ID table entry pointed to by the extracted code is read out and set in the code ID.

Next, in step S607, a determination is made whether the previous code set at step S601 is the partial code string separator code. If the previous code is not the partial code string separator code, in step S608, the code ID set at step S605 is set in the next code ID in the next code ID table entry pointed to by the code ID pointer, and processing proceeds to step S611.

When the determination in step S607 is that the previous code is a partial code string separator code, at step S609, the head code ID in the partial code string is set in the next code ID in the next code ID table entry pointed to by the code ID pointer, and at step S610, the code ID is set in the head code ID in the partial code string, and processing proceeds to step S611.

At step S611, the code ID is set in the code ID pointer, and processing is terminated.

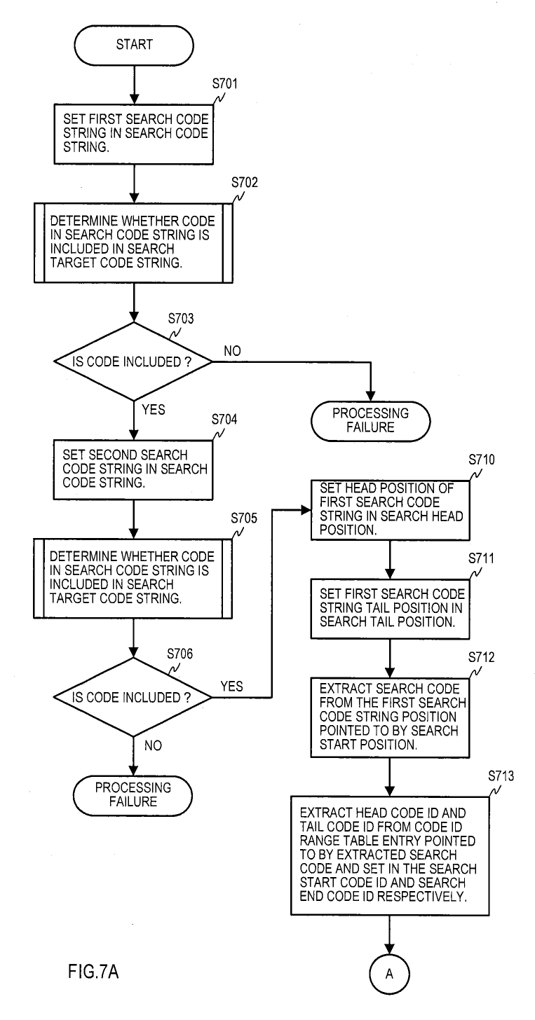

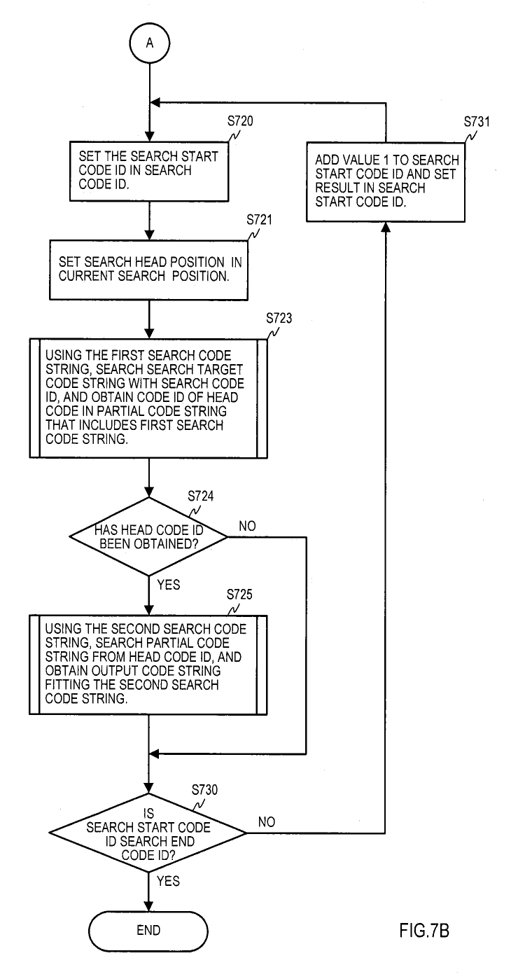

Next, an overview of the processing of a code string search in one embodiment of this invention is described, referencing FIG. 7A and FIG. 7B.

FIG. 7A is a drawing an example of the processing flow in the prior stage of searching for a code string in one embodiment of this invention.

First, in step S701, the first search code string is set in the search code string.

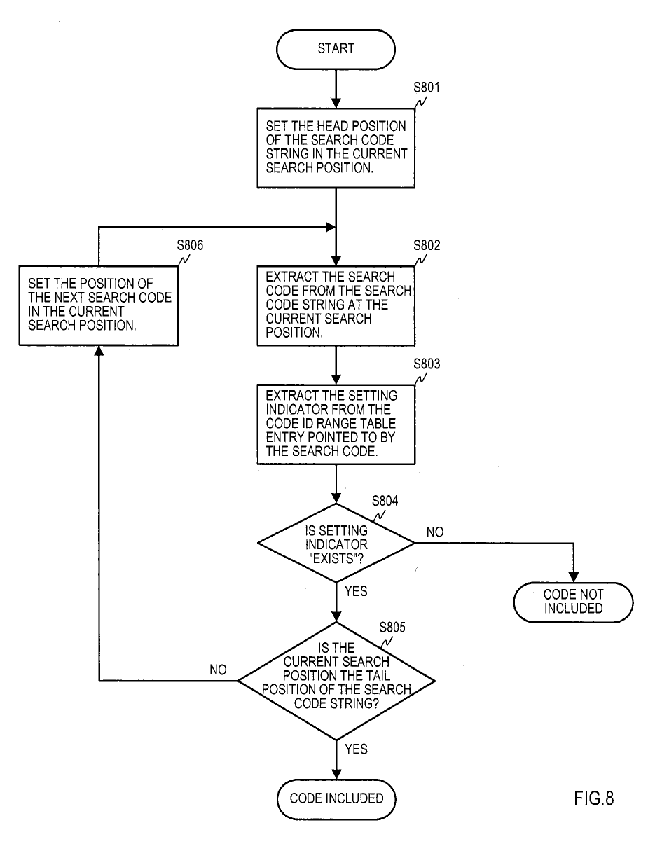

Next, at step S702, a determination is made whether the code in the search code string is included in the search target code string. Details of the processing in step S702 is described below referencing FIG. 8.

Next, in step S703, if the result of the determination in step S702 is that the code in the search code string is not included in the search target code string, the processing is taken to be a failure, and if the determination is that the code in the search code string is included in the search target code string, processing proceeds to step S704, wherein the second search code string is set in the search code string.

Next, in step S705, a determination is made whether the code in the search code string is included in the search target code string. Details of the processing in step S705 described hereinbelow referencing FIG. 8 is the same as the details of the processing in step S702.

Then in step S706, if the result of the determination in step S705 is that the code in the search code string is not included in the search target code string the processing is taken to be a failure, and if the determination is that the code in the search code string is included in the search target code string processing proceeds to step S710, wherein the head position of the first search code string is set in the search head position.

Next, in step S711, the first search code string tail position is set in the search tail position. Next, at step S712, the search code is extracted from the first search code string position pointed to by the search start position set at step S710. Then, at step S713, the head code ID and tail code ID are extracted from the code ID range table entry pointed to by the extracted search code and are set in the search start code ID and search end code ID respectively, and processing proceeds to step S720 shown in FIG. 7B.

FIG. 7B is a drawing describing an example of the processing flow in the latter stage of searching for a code string in one embodiment of this invention.

As shown in the drawing, at step S720, the search start code ID set in the prior stage of processing is set in the search code ID and, at step S721, the search start position set in the prior stage of processing is set in the current search position, and processing proceeds to step S723.

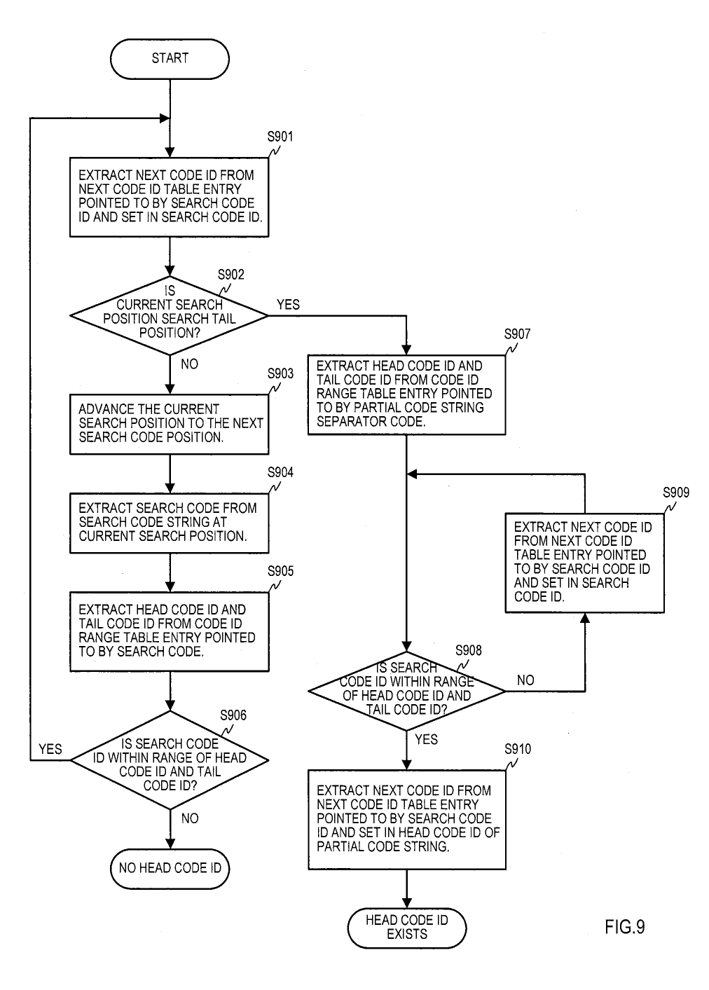

At step S723, using the first search code string, the search target code string is searched with the search code ID, and the code ID of the head code in the partial code string that includes the first search code string is obtained. Details of the processing in step S723 are described hereinbelow referencing FIG. 9.

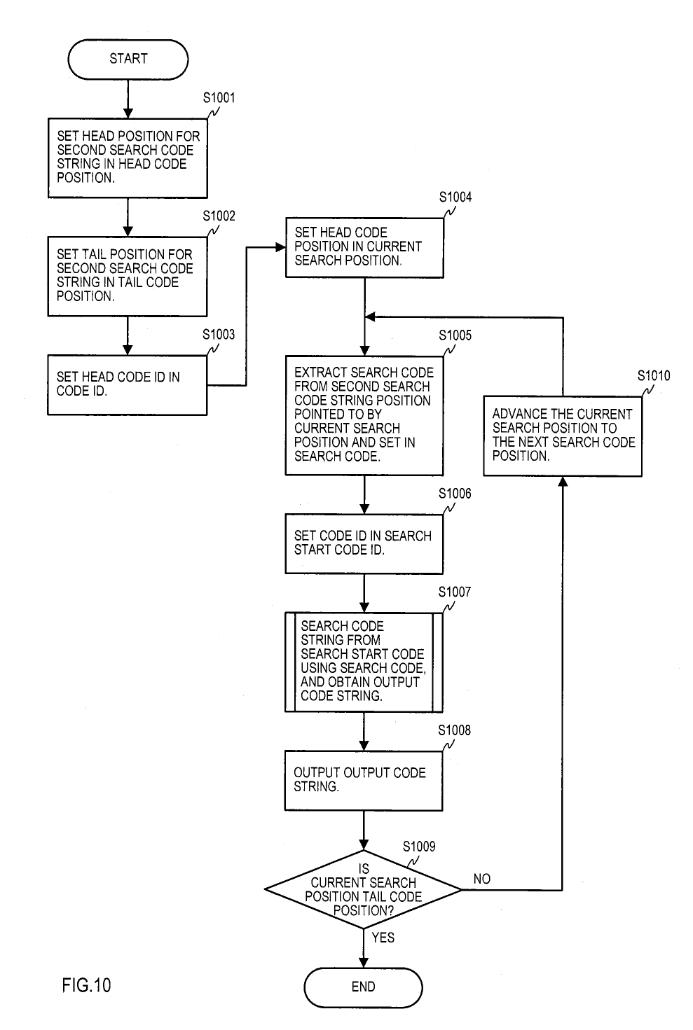

Next, at step S724, a determination is made whether the head code ID has been obtained, and if the determination is negative, processing proceeds to step S730, and if the determination is affirmative and the head code ID has been obtained, at step S725, using the second search code string, the partial code string is searched from the head code ID, and an output code string fitting the second search code string is obtained, and processing proceeds to step S730. Details of the processing in step S725 are described hereinbelow referencing FIG. 10.

At step S730, a determination is made whether the search start code ID is the search end code ID. If the search start code ID is the search end code ID, processing is terminated, and if it is not, in step S731, the value 1 is added to the search start code ID and the result is set in the search start code ID, and processing returns to step S720.

The above processing of the return to step S720 from the determination in step S730 via the update of the search start code ID in step S731 is for the purpose of performing the search in step S723 using the first search code string and the search in step S725 using the second search code string, by changing the search start code ID from the head code ID to the tail code ID in the code ID range table entry pointed to by the head code of the search code string. Saying it in a different way, that is for repeating the processing of verification from the head code of the first search code string to its tail code by changing the code position of the search target code string wherein is positioned a code whose code type is the same as the code type of the head code in the first search code string, and obtaining the head code ID when the verification succeeds, and performing a search using the second search code string, and obtaining output code strings.

Because a determination at step S730 that the search start code ID coincides with the search termination code ID happens when the verify processing has covered all code positions in the search target code string whose code is the same code type as the head code of the first search code string, the overall processing is terminated. The result of the processing is output in step S725.

FIG. 8 is a drawing describing an example of the processing flow to determine whether the search code string is included in the search target code string, and it shows details of the processing in step S702 and step S705 shown in FIG. 7A.

As shown in the drawing, first, at step S801, the head position of the search code string is set in the current search position and processing proceeds to step S802.

At step S802, the search code is extracted from the search code string position pointed to by the current search position, and next, at step S803, the setting indicator is extracted from the code ID range table entry pointed to by the search code, and in step S804 a determination is made whether the extracted setting indicator is “Exists”. If the setting indicator is not “Exists”, because this is to say that the search codes in the search code string do not exist in the search target code string, “code is not included” is returned and processing is terminated.

If the result of the determination in step S804 is that the setting indicator is “Exists”, processing proceeds to step S805, wherein a determination is made whether the current search position set in step S801 or in step S806 described below points to the tail position in the search code string. If the current search position does not point to the tail position in the search code string, at step S806, the position of the next search code is set in the current search position, and processing returns to step S802.

The processing loop of the above steps S802 to S806 is repeated until a determination is made at step S805 that the current search position points to the tail position in the search code string. When the determination is made at step S805 that the current search position points to the tail position in the search code string, “code is included” is returned and processing is terminated.

The processing above shown in FIG. 8 guarantees that the search code in the search code string exists in the search target code string.

FIG. 9 is a drawing describing an example of the processing flow to obtain the head code ID in a partial code string that includes the first search code string and it describes details of the processing in step S723 shown in FIG. 7B.

In the example shown in FIG. 2B and FIG. 2C the first search code string is <A, FS2>. Also, when the processing shown in FIG. 9, in other words, the processing in step S723 shown in FIG. 7B, starts in the first time that the processing loop of steps S720 to S731 is executed, it sets A in the search code, sets ID 13 in the search code ID, and sets the search head position in the current search position.

As shown in the drawing, first, in step S901, the next code ID is extracted from the next code ID table entry pointed to by the search code ID and is set in the search code ID. In the first time processing of the example shown in FIG. 2C and FIG. 2D, ID 4 is extracted as the next code ID and is set in the search code ID.

Next, at step S902, a determination is made whether the current search position is the search tail position, and if it is not the search tail position, in step S903, the current search position is advanced to the position of the next search code in the first search code string, and at step S904, a search code is extracted from the first search code string position pointed to by the current search position, and at step S905, the head code ID and tail code ID are extracted from the code ID range table entry pointed to by the extracted search code. If the determination in step S902 is positive, processing proceeds to step S907. In the example shown in FIG. 2C and FIG. 2D, FS2 is extracted as the search code, and ID 7 and ID 9 are extracted as the head code ID and tail code ID.

Then, in step S906, a determination is made whether the search code ID set at step S901 is within the range of the head code ID and tail code ID extracted at step S905. if it is within that range processing returns to step S901, and if it not within that range “no head code” is returned and this processing is terminated, and processing proceeds to step S724 shown in FIG. 7B.

In the first time processing of the example shown in FIG. 2B and FIG. 2C, ID 4 is made as the search code ID at step S901. Because the head code ID and tail code ID extracted at step S905 are ID 7 and ID 9 respectively, the determination at step S906 results in “no head code” being returned, this processing being terminated, and processing proceeding to step S724 shown in FIG. 7B. Then, when the processing loop of step S720 to step S731 is repeated, and the search start code ID becomes ID 15, and the search code ID is made to be ID 15 at step S720, then the determination in step S906 shown in FIG. 9 becomes affirmative. Because the current search position is advanced at step S903 the determination at step S902 also becomes affirmative and thus the processing moves to step S907 and thereinafter. At this time, in step S901, the search code ID is changed to ID 8.

At step S907, head code ID and tail code ID are extracted from the code ID range table entry pointed to by the partial code string separator code. Then at step S908, a determination is made whether the search code ID is within the range of the head code ID and tail code ID extracted at step S907. If it is not within that range, at step S909, the next code ID is extracted from the next code ID table entry pointed to by the search code ID and is set in the search code ID, processing returns to step S908, and the determination is repeated.

Conversely, when the determination at step S908 is that the search code ID is within the range of the head code ID and tail code ID, that search code ID is that of a partial code string separator code. Then because the next code ID in the next code ID table entry pointed to by the partial code string separator code is the code ID for the head code of that partial code string, in step S910, the next code ID is extracted from the next code ID table entry pointed to by the search code ID and set in the head code ID of the partial code string, processing is terminated, “head code exists” is returned and processing proceeds to step S724 shown in FIG. 7B. Also, at this time, the search code ID, that is, the code ID for the partial code string separator code, can also be output as the code ID for the tail code (tail code ID) for the partial code string.

In the example shown in FIG. 2B and FIG. 2C, in step S907, ID 1 and ID 3 are extracted as the head code ID and tail code ID for code RS. Then the determination in step S908 is repeated while updating the search code ID from ID 8, as shown by the dotted-line arrows 334c to 334e in FIG. 2C, and when the search code ID becomes ID 2, ID 20 that is the next code ID is extracted from the next code ID table entry pointed to by ID 2 in step S910 and is set in the head code ID of the partial code string. At this time, as was noted above, ID 2 can also be output as the tail code ID for the partial code string.

FIG. 10 is a drawing of an example of the processing flow to obtain an output code string that fits the second search code string from the partial code string whose head code ID is obtained by the processing shown FIG. 9, and it describes the details of the processing in step S725 shown in FIG. 7B.

In the example shown in FIG. 2B and FIG. 2D, the second search code string is <FS1, FS3>. Also, ID 20 is set in the head code ID in the partial code string by the processing shown FIG. 9.

As shown in the drawing first, in step S1001, the head position in the second search code string is set in the head code position, and in step S1002, the tail position in the second search code string is set in the tail code position. Also, at step S1003, the head code ID is set in the code ID, and at step S1004, the head code position is set in the current search position, and processing proceeds to step S1005.

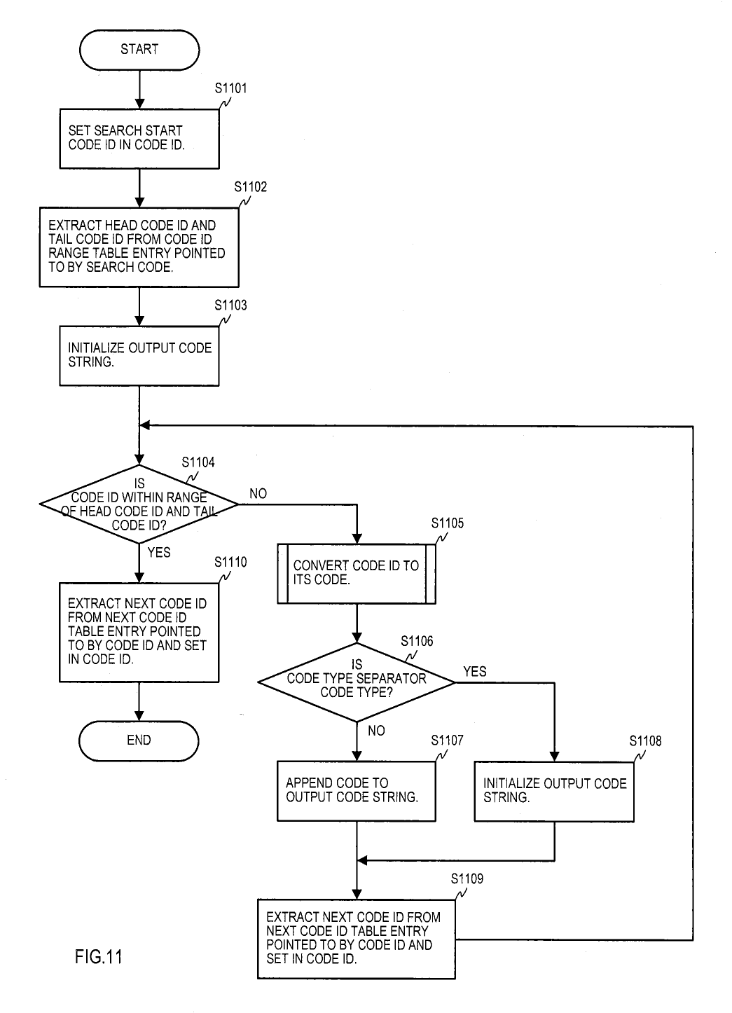

At step S1005, the search code is extracted from the second search code string position pointed to by the current search position and is set in the search code. Next, at step S1006, the code ID is set in the search start code ID, and at step S1007, the code string is searched from the search start code using the search code, and an output code string is obtained. Details of the processing in step S1007 is described hereinbelow referencing FIG. 11.

Next, at step S1008, the output code string is output, and proceeding to step S1009, a determination is made whether the current search position is the tail code position. If the current search position is the tail code position, processing is terminated. And if the current search position is not the tail code position, in step S1010, the current search position is advanced to the position (the search code position) of the next code in the second search code string and processing returns to step S1005.

The processing loop of the above steps S1005 to S1010 is repeated until the determination in step S1009 is that the current search position is the tail code position, and when the determination is that the current search position is the tail code position, processing is terminated.

FIG. 11 is a drawing describing an example of the processing flow to obtain an output code string corresponding to the code separator codes configuring the second search code string from the partial code string, and it describes details of the processing in step S1007 shown in FIG. 10.

As shown in FIG. 11, first, in step S1101, the search start code ID is set in the code ID. The first time the processing shown in the example in FIG. 2B and FIG. 2D is executed ID 20 is set in the code ID.

Next, in step S1102, the head code ID and tail code ID are extracted from the code ID range table entry pointed to by the search code. Also, in step S1103, the output code string is initialized. The first time the processing shown in the example in FIG. 2B and FIG. 2D is executed, because FS1 is set in the search code, ID 4 and ID 6 are extracted as the head code ID and tail code ID.

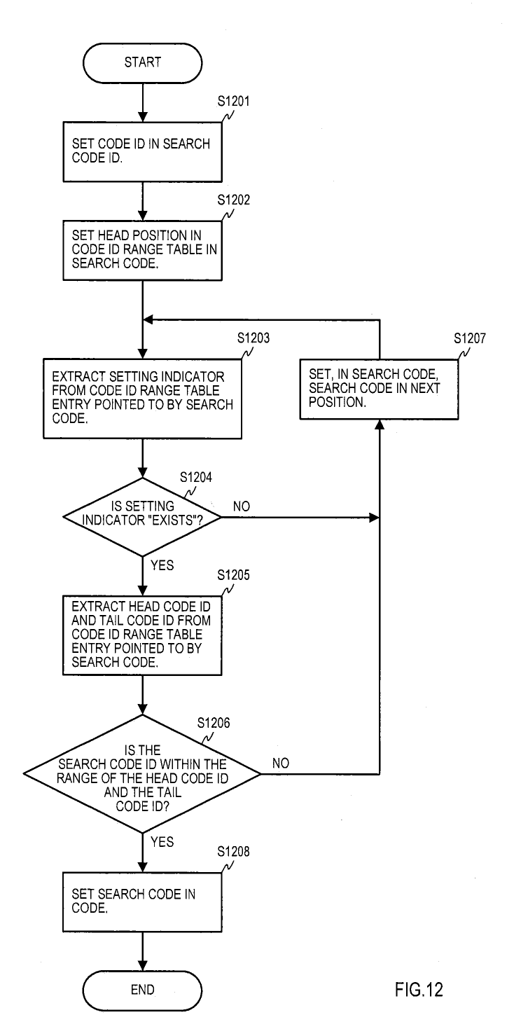

Next, in step S1104, a determination is made whether the code ID is within the range of the head code ID and the tail code ID. If it is not within that range, processing proceeds to step S1105, wherein the code ID is converted to its code. Details of the processing in step S1105 are described hereinbelow referencing FIG. 12. The first time the processing shown in the example in FIG. 2B and FIG. 2D is executed, because the code ID is ID 20, and the head code ID and tail code ID are ID 4 and ID 6 respectively, the determination in step S1104 becomes negative, and at step S1105, C is obtained as the code.

Next, in step S1106, a determination is made whether the type of the code that is obtained by being converted is that of a separator code. If that determination is negative, in step S1107, the code is appended to the output code string and processing proceeds to step S1109. Conversely, if the determination in step S1106 is affirmative, in step S1108, the output code string is initialized and processing proceeds to step S1109.

At step S1109, the next code ID is extracted from the next code ID table entry pointed to by the code ID and is set in the code ID, and processing returns to step S1104.

The first time the processing shown in the example in FIG. 2B and FIG. 2D is executed, at step S1107, C is appended to the output code string, and at step S1109, ID 5, which is the next code ID in the next code ID table entry pointed to by ID 20, is set in the code ID.

At step S1104 noted above, when a determination is made that the code ID is within the range of the head code ID and tail code ID, in step S1110, the next code ID is extracted from the next code ID table entry pointed to by the code ID and is set in the code ID, and processing is terminated.

The first time the processing shown in the example in FIG. 2B and FIG. 2D is executed, in step S1109, because ID 5, which is the next code ID in the next code ID table entry pointed to by ID 20, is set in the code ID, and in the next processing of step S1104, a determination is made that the code ID is within the range of the head code ID and tail code ID, and ID 15 is set in the next code ID in step S1110. Then a return is made to the processing loop of steps S1005 to S1010 shown in FIG. 10, and processing moves to the second processing that outputs the output code string corresponding to the second code separator code, FS3.

The second time the processing shown in the example in FIG. 2B and FIG. 2D is executed, the search code is FS3, its head code ID and tail code ID are ID 10 and ID 12 respectively, and ID 15 is set in the first code ID. Although the ID 15 that is the code ID is converted to code A at step S1105 and at step S1107 is appended to the output code string, because the ID 8 that is the next code ID is not included within the range between the ID 10 that is the head code ID and the ID 12 that is the tail code ID, it is converted to code FS2, and because the code type after conversion is that of a separator code, the output code string is initialized at step S1108.

The code IDs from ID 8 onwards, as shown by the dotted-line arrows 434e and 434f in FIG. 2D, transition from ID 21 to ID 16 to ID 11, and the code C and the code A that are converted from ID 21 and ID 16 are appended to the output code string, and because ID 11 is included within the range between the ID 10 that is the head code ID and the ID 12 that is the tail code ID, the code string CA is output as the output code string.

FIG. 12 is a drawing describing an example of the processing flow to convert the code ID into a code and it describes the details of the processing in step S1105 shown in FIG. 11. As shown in the drawing, first, in step S1201, the code ID is set in the search code ID, and at step S1202, the head position in the code ID range table is set in the search code.

As was described above referencing FIG. 2B, the position of entries corresponding to each code in the code ID range table can be made to correspond to the value of each code. Thus, in FIG. 12, the position of entries corresponding to each code in the code ID range table is taken to be expressed by each code, and is notated as “set the head position of the code ID range table in the search code” or “the code ID range table entry pointed to by the search code”.

Next, in step S1203, the setting indicator is extracted from the code ID range table entry pointed to by the search code, and at step S1204, a determination is made whether the setting indicator is “Exists”. If the setting indicator is “Exists”, processing proceeds to step S1205, and if it is not “Exists”, at step S1207, search code in the next position is set in the search code, and processing returns to step S1203.

Conversely, when the determination at step S1204 is that the setting indicator is “Exists”, processing proceeds to step S1205, and the head code ID and tail code ID are extracted from the code ID range table entry pointed to by the search code. Next, in step S1206, a determination is made whether the search code ID is within the range of the head code ID and tail code ID, and if it is not within that range, a return is made to step S1203 via step S1207 described above.

In step S1206, when the determination is that the search code ID is within the range of the head code ID and tail code ID, processing proceeds to step S1208, and the search code is set in the code, and processing is terminated.

Also, although, in the description above of code string search processing, the code separator codes that configure the second search code string are positioned in the same sequence as the sequence of their positions in the partial code string, the sequence of the code separator codes in the second search code string can be taken in any arbitrary sequence and the search can be executed. In other words, in that case, it is sufficient to make the search start consistently from the start of the partial code string using the second search code string; for that reason, for example, in step S1006 shown in FIG. 10, it is sufficient to set the head code ID in the search start code ID.

It is clear that a code string search apparatus related to this invention executing the code string search in this invention described in detail hereinabove, can be constructed on a computer, for example, by means of a program executed on a computer such as the data processing apparatus 301 shown in the example in FIG. 3.

Also, in the same way, it is clear that the index data creation apparatus that creates index data being used by the code string search method of this invention can be constructed on a computer.

Whereat, an example of a function block configuration related to the index data creation apparatus and the code string search apparatus of this invention is described hereinbelow.

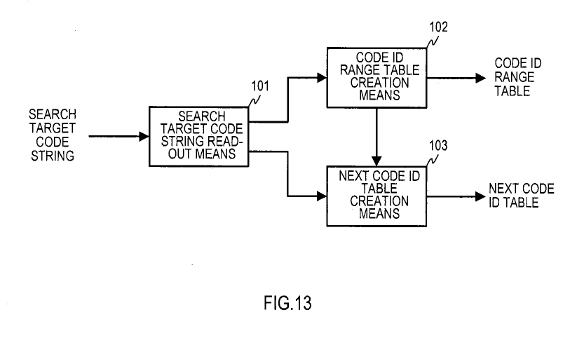

FIG. 13 is a drawing describing an example of a function block configuration for creating the data structure for an index in one embodiment of this invention. A search target code string is read out by the search target code string read-out means 101 and is passed to the code ID range table creation means 102 and the next code ID table creation means 103. The code ID range table creation means 102 creates a code ID range table holding the range of code IDs for each code. The next code ID table creation means 103 creates a next code ID table holding, corresponding to each of the code IDs except for the second separator code, a next ID code, which is a code ID of a code located next to a code whose code ID is the corresponding code ID in the search target code string and holding, as a next code ID, for each of the code IDs of second separator codes, the code ID of a head code in each of the partial code strings related to the second separator codes. This code ID range table and this next code ID table are created for each of the code strings that are the target of searches.

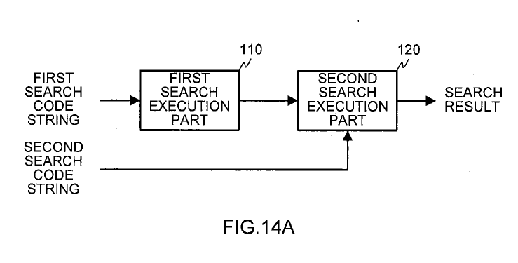

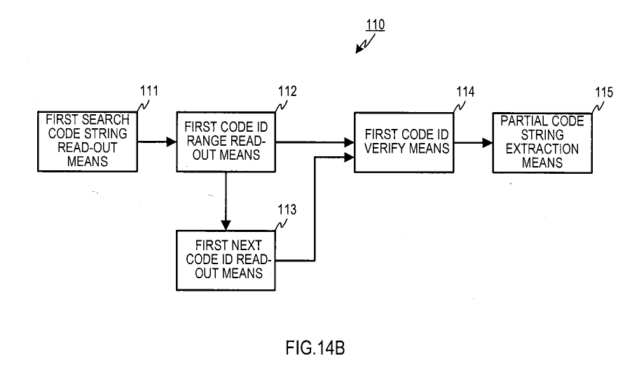

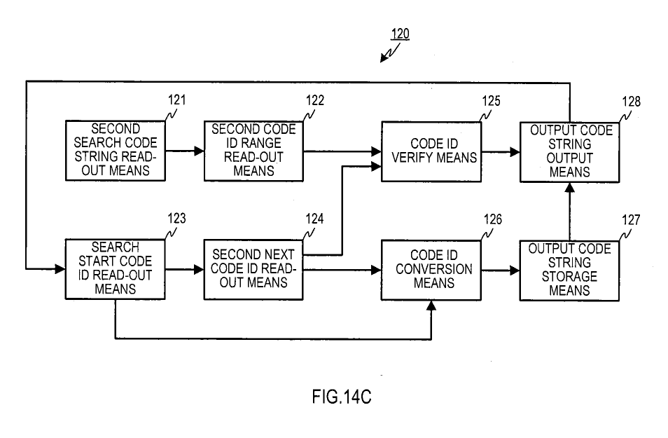

FIG. 14A is a drawing describing an example of a function block configuration for a code string search apparatus in one embodiment of this invention. The first search execution part 110 searches the search target code string based on the first search code string and the code ID of the head code in the partial code string is obtained as the first search start code ID for the second search execution part 120.

The second search execution part 120 searches the partial code string from that head code, based on the second search code string, and outputs as search results a code string fitting the second search code string.

FIG. 14B is a drawing describing an example of a function block configuration for the first search execution part in one embodiment of this invention. The first search code string read-out means 111 reads out the first search code string and passes it to the first code ID range read-out means 112. The first code ID range read-out means 112 reads out the range of the code IDs of the codes that compose the first search code string passed from the first search code string read-out means 111 from the code ID range table created by the code ID range table creation means 102, and passes them to the first next ID read-out means 113 and the first code ID verify means 114.

The first next code ID read-out means 113 reads out, from the next code ID table created by the next code ID table creation means 103, the next code ID stored in association with a code ID included in the code ID range of the head code in the first search code string passed by the first code ID range read-out means 112 and at the same time successively reads out from the next code ID table a next code ID stored in correspondence with that next code and passes it to the first code ID verify means 114.

The first code ID verify means 114 verifies whether the next code ID passed from the first next code ID read-out means 113 is included in the range of code IDs passed from the first code ID range read-out means 112 and passes the verification result to the partial code string extraction means 115. When the partial code string extraction means 115 receives verification results showing that the next code ID read out by the first next code ID read-out means 113 is included in the code ID range for the first separator code in the first search code string read out by the first code ID range read-out means 112, the partial code string extraction means 115 successively reads out the stored next code IDs corresponding to the next code ID from the next code ID table and determines whether the read-out next code ID is included within the code ID range of the second separator code and when the determination is that the read-out next code ID is included within the code ID range of the second separator code, the partial code string extraction means 115 sets the next code ID stored in the next code ID table entry corresponding to the read-out next code ID as the search start code ID for the partial code string.

FIG. 14C is a drawing describing an example of a function block configuration for the second search execution part in one embodiment of this invention. The second search code string read-out means 121 reads out the second search code string, and the second code ID range read-out means 122 successively reads out, for each code configuring the second search code string read out by second search code string read-out means 121, starting from the head code, the code ID range for that code type from the code ID range table.

The search start code ID read-out means 123 reads out the search start code ID set by the partial code string extraction means 115 or the search start code ID updated by the output code string output means 128. The second next code ID read-out means 124 reads out, from the next code ID table, the stored next code ID corresponding to the search start code ID read out by the search start code ID read-out means 123 and, thereafter, successively reads out the stored next code IDs corresponding to that next code ID from the next code ID table.

The second code ID verify means 125 verifies whether the next code ID read out by the second ID read-out means 124 is included in the range of code IDs read out by the second code ID range read-out means 122 and the code ID conversion means 126 converts the search start code ID read out by the search start code ID read-out means 123 and the next code ID read out by the second next ID read-out means 124 into codes.

The output code string storage means 127 successively appends the codes converted by the code ID conversion means 126 and stores them as an output code string. When the next code ID read out by the second next ID read-out means 124 is determined by the second code ID verify means 125 to be included in the code ID range for the first separator code in the second search code string read out by the code ID range read-out means 122, the output code string output means 128 outputs the output code string stored in the output code string storage means 127 as a code string for search results fitting the second search code string while reading out, from the next code ID table, the stored next code ID corresponding to the next code ID read out by the second next ID read-out means 124 and updating the search start code ID by the read-out next code ID.

Although the above described details of preferable modes for implementing this invention, it is not limited to those preferred embodiments and it will be clear to one skilled in the art that various modifications are possible.

It is also clear that the index data creation method of this invention and art-recognized equivalents can be implemented by programs executing on a computer the processing of creating index data for the code string search shown in FIG. 5A to FIG. 5C and FIG. 6. Also it is clear that the code string search method of this invention can be constructed on a computer by programs that a computer is caused to execute by the processing for code string searches shown in FIG. 7A to FIG. 12 and art-recognized equivalents.

Therefore, the programs, and a computer-readable storage medium into which the programs are stored are encompassed by the embodiments of the present invention. Furthermore, the data configuration of the index data for the code string searches of this invention and a computer-readable storage medium wherein is stored the index data using that data configuration are also encompassed by the embodiments of the present invention.

What is claimed is:

1. A code string search apparatus that
searches a search target code string that is the object of a search and is configured from
partial code strings, each of the partial code strings being a combination of a data code or a data code string expressing data and a first separator code that expresses separator positions between the data code or the data code string, and
a second separator code expressing the separator position for the partial code strings,
by means of a first search code string that is configured from the data code or the data code string and the first separator code
so as to obtain the partial code string that includes the first search code string, and
searches the obtained partial code string by means of a second search code string that is the first separator code or a code string configured from the first separator code so as to output the data code or data code string fitting the second search code string as an output code string,
the code string search apparatus comprising:
a code ID range table holding a code ID range for codes of a same code type, which is a range of code IDs uniquely identifying each and every code located in the search target code string;
a next code ID table
holding, corresponding to each of the code IDs except the second separator code, a next ID code, which is a code ID of a code located next to a code whose code ID is the corresponding code ID in the search target code string and
holding, as a next code ID, for each of the code IDs of second separator codes, the code ID of a head code in each of the partial code strings related to the second separator codes;
a first search execution part that, referencing the code ID range table and the next code ID table, executes a search using the first search code string;
a second search execution part that, referencing the code ID range table and the next code ID table, executes a search using the second search code string;
wherein the first search execution part includes
a first search code string read-out means that reads out the first search code string, and
a first code ID range read-out means that successively reads out from the code ID range table a code ID range pointed to by a code type of each code from the head code configuring the search code string read out by the first search code string read-out means, and
a first next code ID read-out means that
reads out from the next code ID table a next code ID held corresponding to the code ID included within the code ID range of the head code type in the search code string and read out by the first code ID range read-out means, and thereafter
successively reads out from the next code ID table the next code ID held corresponding to the read-out next code ID, and
a first code ID verify means that verifies whether the next code ID read out by the first next ID read-out means is included within the code ID range read out by the first code ID range read-out means, and
a partial code string extraction means that
when the first code ID verify means determines that the next code ID read out by the first next ID read-out means is included within the code ID range for the first separator code in the first search code string read out by the first code ID range read-out means,
successively reads out, from the next code ID table, a next code ID held corresponding to the next code ID and
determines whether the read-out next code ID is included within the code ID range for the second separator code, and
when the determination is that the read-out next code ID is included within the code ID range for the second separator code,
sets the next code ID held in the next code ID table corresponding to the read-out next code ID as a search start code ID for a partial code string; and wherein
the second search execution part includes
a second search code string read-out means that reads out the second search code string, and
a second code ID range read-out means that successively reads out from the code ID range table a code ID range pointed to by a code type of each code from the head code configuring the search code string read out by the second search code string read-out means, and
a search start code ID read-out means that
reads out the search start code ID set by the partial code string extraction means or the search start code ID modified by the output code string output means described below, and
a second next code ID read-out means that
reads out from the next code ID table a next code ID held corresponding to the search start code ID read out by the search start code ID read-out means and after that
successively reads out from the next code ID table the next code ID held corresponding to the read-out next code ID, and
a second code ID verify means that verifies whether the next code ID read out by the second next code ID read-out means is included within the code ID range read out by the second code ID range read-out means, and
a code ID conversion means that converts the search start code ID read out by the search start code ID read-out means and the next code ID read out by the second next code ID read-out means into codes, and
an output code string storage means that
successively appends each of the codes converted by the code ID conversion means so as to generate a code string and
stores the code string as an output code string, and
an output code string output means that,
when the second code ID verify means determines that the next code ID read out by the second next code ID read-out means is included within the code ID range for the first separator code in the second search code string read out by the second code ID range read-out means,
outputs the output code string stored in the output code string storage means as a search result code string fitting the second search code string and,
by reading out from the next code ID table a next code ID held corresponding to the next code ID,
modifies the search start code ID by means of the read-out next code ID.

2. The code string search apparatus according to claim 1, wherein,
when a head code ID is taken to be a first code ID, which head code ID is included within the code ID range pointed to by the code type of a first code which is the head code in the first search code string,
the first code ID verify means verifies whether the next code ID held corresponding to the first code ID is included within the code ID range pointed to by the code type of a second code which is the code positioned next after the first code in the search target code string, and thereafter,
when the positions of the first code and second code in the search code string are modified by the read-out operations of the first code ID range read-out means and the first next ID read-out means,
the first code ID verify means verifies whether the next code ID held corresponding to the code ID of the first code, whose position has been modified, is included within the code ID range pointed to by a code type of the second code, whose position has been modified.

3. The code string search apparatus according to claim 2, wherein
the output code string output means deletes the output code string stored in the output code string storage means
if the code converted from the next code by the code ID conversion means is not a data code and the next code ID is determined by the second code ID verify means not to be included within the code ID range read out by the second code ID range read-out means.

4. The code string search apparatus according to claim 3, wherein
the first code ID verify means, using each of all the code IDs included within the code ID range pointed to by the code type of the head code in the first search code string as a head code ID,
verifies whether the next code ID read out by the first next ID read-out means is included within the code ID range read out by the code ID range read-out means.

5. A code string search method performed by the code string search apparatus according to claim 1, comprising:
a first search code string read-out step that reads out the first search code string;
a first code ID range read-out step that successively reads out from the code ID range table a code ID range pointed to by a code type of each code from the head code configuring the search code string read out by the search code string read-out step;
a first next ID read-out step that
reads out from the next code ID table a next code ID held corresponding to the code ID included within the code ID range of the head code type in the search code string and read out by the first code ID range read-out step, and thereafter
successively reads out from the next code ID table the next code ID held corresponding to the read-out next code ID;
a first code ID verify step that verifies whether the next code ID read out by the first next ID read-out step is included within the code ID range read out by the first code ID range read-out step;
a partial code string extraction step that
when the first code ID verify step determines that the next code ID read out by the first next ID read-out step is included within the code ID range for the first separator code in the first search code string read out by the first code ID range read-out step,
successively reads out, from the next code ID table, a next code ID held corresponding to the next code ID and
determines whether the read-out next code ID is included within the code ID range for the second separator code, and
when the determination is that the read-out next code ID is included within the code ID range for the second separator code,
sets the next code ID held in the next code ID table corresponding to the read-out next code ID as a search start code ID for a partial code string;
a second search code string read-out step that reads out the second search code string;
a second code ID range read-out step that successively reads out from the code ID range table a code ID range pointed to by a code type of each code from the head code configuring the search code string read out by the second search code string read-out step;
a search start code ID read-out step that
reads out the search start code ID set by the partial code string extraction step or the search start code ID modified by the output code string output step described below;
a second next code ID read-out step that
reads out from the next code ID table a next code ID held corresponding to the search start code ID read out by the search start code ID read-out step and after that
successively reads out from the next code ID table the next code ID held corresponding to the read-out next code ID;
a second code ID verify step that verifies whether the next code ID read out by the second next code ID read-out step is included within the code ID range read out by the second code ID range read-out step;
a code ID conversion step that converts the search start code ID read out by the search start code ID read-out step and the next code ID read out by the second next code ID read-out step into codes;
an output code string storage step that
successively appends each of the codes converted by the code ID conversion step so as to generate a code string and
stores the code string as an output code string; and
an output code string output step that,
when the second code ID verify step determines that the next code ID read out by the second next code ID read-out step is included within the code ID range for the first separator code in the second search code string read out by the second code ID range read-out step,
outputs the output code string stored in the output code string storage step as a search result code string fitting the second search code string and, by reading out from the next code ID table a next code ID held corresponding to the next code ID,
modifies the search start code ID by means of the read-out next code ID.

6. The code string search method according to claim 5, wherein,
when a head code ID is taken to be a first code ID, which head code ID is included within the code ID range pointed to by the code type of a first code which is the head code in the first search code string,
the first code ID verify step verifies whether the next code ID held corresponding to the first code ID is included within the code ID range pointed to by the code type of a second code which is the code positioned next after the first code in the search target code string, and thereafter,
when the positions of the first code and second code in the search code string are modified by the read-out operations of the first code ID range read-out step and the first next ID read-out step,
the first code ID verify step verifies whether the next code ID held corresponding to the code ID of the first code, whose position has been modified, is included within the code ID range pointed to by a code type of the second code, whose position has been modified.

7. The code string search method according to claim 6, wherein
the output code string output step deletes the output code string stored in the output code string storage means
if the code converted from the next code by the code ID conversion step is not a data code and the next code ID is determined by the second code ID verify step not to be included within the code ID range read out by the second code ID range read-out step.

8. The code string search method according to claim 7, wherein
the first code ID verify step, using each of all the code IDs included within the code ID range pointed to by the code type of the head code in the first search code string as a head code ID,
verifies whether the next code ID read out by the first next ID read-out step is included within the code ID range read out by the code ID range read-out step.

9. A code string search program for causing a computer which realizes the code string search apparatus according to claim 1 to execute a code string search method, comprising:
a first search code string read-out step that reads out the first search code string;
a first code ID range read-out step that successively reads out from the code ID range table a code ID range pointed to by a code type of each code from the head code configuring the search code string read out by the search code string read-out step;
a first next ID read-out step that
reads out from the next code ID table a next code ID held corresponding to the code ID included within the code ID range of the head code type in the search code string and read out by the first code ID range read-out step, and thereafter
successively reads out from the next code ID table the next code ID held corresponding to the read-out next code ID;
a first code ID verify step that verifies whether the next code ID read out by the first next ID read-out step is included within the code ID range read out by the first code ID range read-out step;
a partial code string extraction step that
when the first code ID verify step determines that the next code ID read out by the first next ID read-out step is included within the code ID range for the first separator code in the first search code string read out by the first code ID range read-out step,
successively reads out, from the next code ID table, a next code ID held corresponding to the next code ID and
determines whether the read-out next code ID is included within the code ID range for the second separator code, and
when the determination is that the read-out next code ID is included within the code ID range for the second separator code,
sets the next code ID held in the next code ID table corresponding to the read-out next code ID as a search start code ID for a partial code string;
a second search code string read-out step that reads out the second search code string;
a second code ID range read-out step that successively reads out from the code ID range table a code ID range pointed to by a code type of each code from the head code configuring the search code string read out by the second search code string read-out step;
a search start code ID read-out step that
reads out the search start code ID set by the partial code string extraction step or the search start code ID modified by the output code string output step described below;
a second next code ID read-out step that
reads out from the next code ID table a next code ID held corresponding to the search start code ID read out by the search start code ID read-out step and after that
successively reads out from the next code ID table the next code ID held corresponding to the read-out next code ID;
a second code ID verify step that verifies whether the next code ID read out by the second next code ID read-out step is included within the code ID range read out by the second code ID range read-out step;
a code ID conversion step that converts the search start code ID read out by the search start code ID read-out step and the next code ID read out by the second next code ID read-out step into codes;
an output code string storage step that
successively appends each of the codes converted by the code ID conversion step so as to generate a code string and
stores the code string as an output code string; and
an output code string output step that,
when the second code ID verify step determines that the next code ID read out by the second next code ID read-out step is included within the code ID range for the first separator code in the second search code string read out by the second code ID range read-out step,
outputs the output code string stored in the output code string storage step as a search result code string fitting the second search code string and, by reading out from the next code ID table a next code ID held corresponding to the next code ID,
modifies the search start code ID by means of the read-out next code ID.

10. The code string search program according to claim 9, wherein,
when a head code ID is taken to be a first code ID, which head code ID is included within the code ID range pointed to by the code type of a first code which is the head code in the first search code string,
the first code ID verify step verifies whether the next code ID held corresponding to the first code ID is included within the code ID range pointed to by the code type of a second code which is the code positioned next after the first code in the search target code string, and thereafter,
when the positions of the first code and second code in the search code string are modified by the read-out operations of the first code ID range read-out step and the first next ID read-out step,
the first code ID verify step verifies whether the next code ID held corresponding to the code ID of the first code, whose position has been modified, is included within the code ID range pointed to by a code type of the second code, whose position has been modified.

11. The code string search program according to claim 10, wherein
the output code string output step deletes the output code string stored in the output code string storage means
if the code converted from the next code by the code ID conversion step is not a data code and the next code ID is determined by the second code ID verify step not to be included within the code ID range read out by the second code ID range read-out step.

12. The code string search program according to claim 11, wherein
the first code ID verify step, using each of all the code IDs included within the code ID range pointed to by the code type of the head code in the first search code string as a head code ID,
verifies whether the next code ID read out by the first next ID read-out step is included within the code ID range read out by the code ID range read-out step.

13. A computer readable storage medium storing the code string search program according to claim 9.

14. A data configuration adapted to a code string search method for searching for a search target code string that is the object of a search and is configured from
partial code strings, each of the partial code strings being a combination of a data code or a data code string expressing data and a first separator code that expresses separator positions between the data code or the data code string, and
a second separator code expressing the separator position for the partial code strings,
by means of a first search code string that is configured from the data code or the data code string and the first separator code
so as to obtain the partial code string that includes the first search code string, and
searches the obtained partial code string by means of a second search code string that is the first separator code or a code string configured from the first separator code so as to output the data code or data code string fitting the second search code string as an output code string,
the data configuration comprising:
a code ID range table holding a code ID range for codes of a same code type, which is a range of code IDs uniquely identifying each and every code located in the search target code string;
a next code ID table
holding, corresponding to each of the code IDs except the second separator code, a next ID code, which is a code ID of a code located next to a code whose code ID is the corresponding code ID in the search target code string and
holding, as a next code ID, for each of the code IDs of second separator codes, the code ID of a head code in each of the partial code strings related to the second separator codes; and wherein
the code string search method according to claim 5 is enabled by using the code ID range table and the next code ID table.

15. A computer readable storage medium storing data with the data configuration according to claim 14.

16. An index data creation apparatus for creating the index data for a code string search that
searches a search target code string that is the object of a search and is configured from
partial code strings, each of the partial code strings being a combination of a data code or a data code string expressing data and a first separator code that expresses separator positions between the data code or the data code string, and
a second separator code expressing the separator position for the partial code strings,
by means of a first search code string that is configured from the data code or the data code string and the first separator code
so as to obtain the partial code string that includes the first search code string, and
searches the obtained partial code string by means of a second search code string that is the first separator code or a code string configured from the first separator code so as to output the data code or data code string fitting the second search code string as an output code string,
the index data creation apparatus comprising:
a search target code string read-out means that reads out the search target code string and obtains the number of occurrences of each code type for the codes in the read-out search target code string;
a code ID range table creation means that
creates a code ID range table holding a code ID range for each code of a same code type, which is a range of code IDs uniquely identifying each and every code positioned in the search target code string, based on the number of occurrences of each code type obtained by the search target code string read-out means;
a next code ID table creation means that
creates a next code ID table holding, corresponding to each of the code IDs, a next code ID, which is a code ID of a code located next to a code whose code ID is the corresponding code ID in the search target code string,
based on the search target code string read out by the search target code string read-out means and the code ID range table created by the code ID range table creation means; and wherein
the next code ID table creation means, in correspondence to code IDs for the second separator code, stores a head code in a partial code string separated by the second separator code in the next code ID table instead of the code ID of the code located next to the second separator code.

17. An index data creation method performed by the code string search apparatus according to claim 16, comprising:
a search target code string read-out step that reads out the search target code string and obtains the number of occurrences of each code type for the codes in the read-out search target code string;
a code ID range table creation step that
creates a code ID range table holding a code ID range for each code of a same code type, which is a range of code IDs uniquely identifying each and every code positioned in the search target code string, based on the number of occurrences of each code type obtained by the search target code string read-out step;
a next code ID table creation means that
creates a next code ID table holding, corresponding to each of the code IDs, a next code ID, which is a code ID of a code located next to a code whose code ID is the corresponding code ID in the search target code string,
based on the search target code string read out by the search target code string read-out means and the code ID range table created by the code ID range table creation step; and wherein
the next code ID table creation step, in correspondence to code IDs for the second separator code, stores a head code in a partial code string separated by the second separator code in the next code ID table instead of the code ID of the code located next to the second separator code.

18. An index data creation program for causing a computer which realizes the index data creation apparatus according to claim 16 to execute an index data creation method, comprising:
a search target code string read-out step that reads out the search target code string and obtains the number of occurrences of each code type for the codes in the read-out search target code string;
a code ID range table creation step that
creates a code ID range table holding a code ID range for each code of a same code type, which is a range of code IDs uniquely identifying each and every code positioned in the search target code string, based on the number of occurrences of each code type obtained by the search target code string read-out step;
a next code ID table creation means that
creates a next code ID table holding, corresponding to each of the code IDs, a next code ID, which is a code ID of a code located next to a code whose code ID is the corresponding code ID in the search target code string,
based on the search target code string read out by the search target code string read-out means and the code ID range table created by the code ID range table creation step; and wherein
the next code ID table creation step, in correspondence to code IDs for the second separator code, stores a head code in a partial code string separated by the second separator code in the next code ID table instead of the code ID of the code located next to the second separator code.

19. A computer readable storage medium storing the index data creation program according to claim 18.
